(19) United States
(12) Patent Application Publication
(10) Pub. No.: US 2023/0215050 A1
(43) Pub. Date: Jul. 6, 2023

(54) INFORMATION PROCESSING APPARATUS, METHOD, AND STORAGE MEDIUM TO GENERATE A COLOR-DIFFERENCE MAP

(71) Applicant: CANON KABUSHIKI KAISHA, Tokyo (JP)

(72) Inventors: KIMITAKA ARAI, Kanagawa (JP); TAKAMASA SETO, Kanagawa (JP)

(21) Appl. No.: 18/149,579

(22) Filed: Jan. 3, 2023

(30) Foreign Application Priority Data
Jan. 6, 2022 (JP) 2022-000995

(51) Int. Cl. G06T 7/90; G06T 7/11; G06T 11/20

(52) U.S. Cl. CPC G06T 7/90; G06T 7/11; G06T 11/203; G06T 2200/24; G06T 2207/10024; G06T 2207/20092

(57) ABSTRACT

An information processing apparatus sets a first line segment in an image obtained by image capturing, and also sets a second line segment in the image. Then, the information processing apparatus acquires color differences between points on the first line segment and points on the second line segments, and generates a color-difference map based on the acquired color differences.

### BACKGROUND

### Field

Aspects of the present disclosure generally relate to a technique to generate a color-difference map based on an image and, more particularly, to an information processing apparatus, method, and medium.

### Description of the Related Art

Recently, there have been an increasing number of cases which use a camera instead of a color measuring device and perform color inspection by referring to color distribution information obtained from pixel values of a captured image. Examples of such a technique to treat color data extracted from a captured image include a technique discussed in Japanese Patent Application Laid-Open No. 2017-229064. The technique discussed in Japanese Patent Application Laid-Open No. 2017-229064 displays, as a map, color differences between a designated reference point and respective positions of the image. According to this technique, it is possible to display a two-dimensional distribution of color differences with respect to the reference point.

However, a color-difference map generated by the above-mentioned technique is generated based on color differences with respect to the single reference point and is, therefore, limited in application in some degree, so that it cannot be said to be a color-difference map which is applicable to various uses and needs.

### SUMMARY

Aspects of the present disclosure are generally directed to enabling generating a color-difference map which is applicable to various uses and needs.

According to some embodiments, an information processing apparatus includes a first setting unit configured to set a first line segment in an image obtained by image capturing, a second setting unit configured to set a second line segment in the image, a color difference acquisition unit configured to acquire color differences between points on the first line segment and points on the second line segments, and a generation unit configured to generate a color-difference map based on the acquired color differences.

Further features of the present disclosure will become apparent from the following description of exemplary embodiments with reference to the attached drawings.

### BRIEF DESCRIPTION OF THE DRAWINGS

FIG. 1 is a diagram illustrating a hardware configuration of an information processing apparatus according to some embodiments.

FIG. 2 is a diagram illustrating a logical configuration of an information processing apparatus according to a first exemplary embodiment.

FIG. 3 is a flowchart illustrating the entirety of information processing in the first exemplary embodiment.

FIG. 4 is a diagram illustrating an example of a user interface (UI) in the first exemplary embodiment.

FIG. 5 is a state transition diagram for the information processing apparatus corresponding to UI inputs in the first exemplary embodiment.

FIG. 6 is a flowchart of evaluation line calculation processing in the first exemplary embodiment.

FIG. 7 is a flowchart of color difference calculation processing in the first exemplary embodiment.

FIG. 8 is a flowchart of color-difference map generation processing in the first exemplary embodiment.

FIG. 9 is a diagram illustrating a logical configuration of an information processing apparatus according to a second exemplary embodiment.

FIG. 10 is a flowchart illustrating the entirety of information processing in the second exemplary embodiment.

FIG. 11 is a diagram illustrating an example of a UI in the second exemplary embodiment.

FIG. 12 is a state transition diagram for the information processing apparatus corresponding to UI inputs in the second exemplary embodiment.

FIG. 13 is a diagram illustrating a logical configuration of an information processing apparatus according to a third exemplary embodiment.

FIG. 14 is a flowchart illustrating the entirety of information processing in the third exemplary embodiment.

FIG. 15 is a diagram illustrating an example of a UI in the third exemplary embodiment.

FIG. 16 is a state transition diagram for the information processing apparatus corresponding to UI inputs in the third exemplary embodiment.

FIG. 17 is a flowchart of evaluation line calculation processing in the third exemplary embodiment.

FIG. 18 is a flowchart illustrating the entirety of information processing in a fourth exemplary embodiment.

FIG. 19 is a diagram illustrating an example of a UI in the fourth exemplary embodiment.

FIG. 20 is a state transition diagram for the information processing apparatus corresponding to UI inputs in the fourth exemplary embodiment.

FIG. 21 is a flowchart of processing associated with new node point addition.

FIG. 22 is a flowchart of evaluation line calculation processing in the fourth exemplary embodiment.

FIG. 23 is a diagram illustrating a logical configuration of an information processing apparatus according to a fifth exemplary embodiment.

FIG. 24 is a flowchart illustrating the entirety of information processing in the fifth exemplary embodiment.

FIG. 25 is a diagram illustrating an example of a UI in the fifth exemplary embodiment.

FIG. 26 is a state transition diagram for the information processing apparatus corresponding to UI inputs in the fifth exemplary embodiment.

FIGS. 27A and 27B are flowcharts of reference line calculation processing in the fifth exemplary embodiment.

FIGS. 28A and 28B are explanatory diagrams for reference lines which are calculated depending on differences of options.

FIG. 29 is a diagram illustrating a table for a list in the fifth exemplary embodiment.

FIGS. 30A, 30B, and 30C are explanatory diagrams for processing for dividing a boundary line.

FIG. 31 is a flowchart of evaluation line calculation processing in the fifth exemplary embodiment.

FIGS. 32A and 32B are flowcharts of color-difference map generation processing in the fifth exemplary embodiment.

### DESCRIPTION OF THE EMBODIMENTS

Various exemplary embodiments, features, and aspects of the disclosure will be described in detail below with reference to the drawings. Furthermore, the following exemplary embodiments should not be construed to limit the present disclosure, and, moreover, not all of the combinations of features described in the exemplary embodiments are necessarily essential to the present disclosure. Configurations illustrated in the following exemplary embodiments are merely examples, and the present disclosure should not be construed to be limited to the illustrated configurations. Moreover, in the description of the exemplary embodiments described below, the same constituent elements are assigned the respective same reference characters.

### Hardware Configuration of Information Processing Apparatus

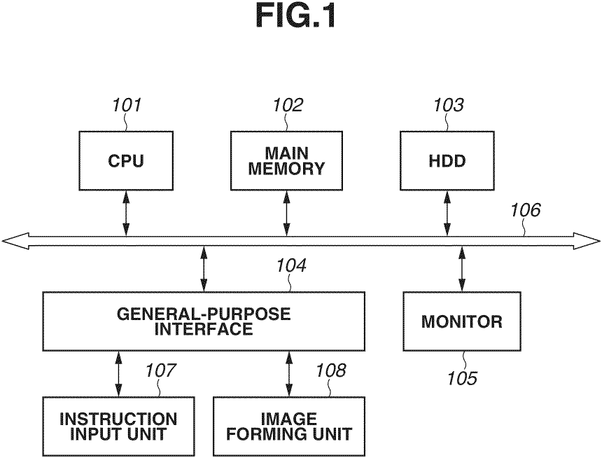

FIG. 1 is a diagram illustrating a hardware configuration example of an information processing apparatus according to some embodiments.

A central processing unit (CPU) 101, which includes one or more processors, circuitry, or combinations thereof, executes an operating system (OS) and various programs stored in a hard disk drive (HDD) 103 while using a main memory 102 as a work memory and thus controls respective constituent elements via a system bus 106. Moreover, the CPU 101 uses the HDD 103 and other various recording media as storage locations for reading and writing. The programs which the CPU 101 executes include a program for performing an information processing flow according to each exemplary embodiment described below.

Moreover, the CPU 101 also performs displaying, on a monitor 105, a user interface (UI) which the program provides and thus receiving, for example, an instruction input by the user via an instruction input unit 107. Furthermore, while, in the present exemplary embodiment, an instruction from the user is input to the information processing apparatus via the instruction input unit 107, in the subsequent description, for ease of description, the statement that a user instruction is input via the instruction input unit 107 is omitted as appropriate.

A general-purpose interface (I/F) 104 is a serial bus interface such as a Universal Serial Bus (USB), to which, for example, the instruction input unit 107, such as a mouse and a keyboard, and an image forming unit 108 are connected. According to some embodiments, the term ‘unit’ generally refers to firmware, software, hardware, circuitry, or combinations thereof that have respective functions or are used to effectuate a purpose.

Here, information processing in the present exemplary embodiment which is performed by the CPU 101 executing an information processing application in the configuration illustrated in FIG. 1 is described.

### Logical Configuration of Information Processing Apparatus in First Exemplary Embodiment

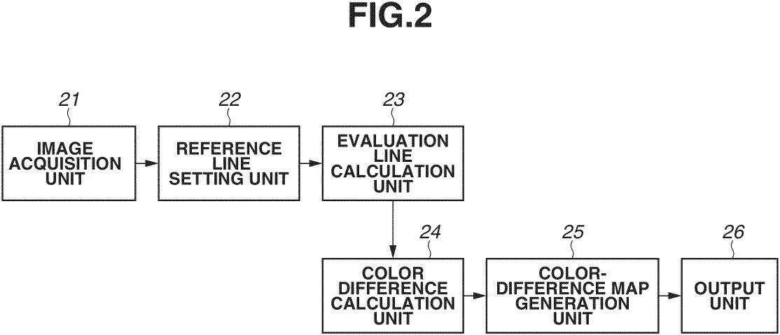

FIG. 2 is a diagram illustrating a logical configuration of an information processing apparatus according to a first exemplary embodiment. The information processing apparatus in the present exemplary embodiment has a logical configuration illustrated in FIG. 2 as a configuration which enables setting a plurality of reference points and a plurality of evaluation points within an image acquired by image capturing and generating and displaying, as a color-difference map, color differences between the plurality of reference points and the plurality of evaluation points. Thus, the information processing apparatus in the present exemplary embodiment includes an image acquisition unit 21, a reference line setting unit 22, an evaluation line calculation unit 23, a color difference calculation unit 24, a color-difference map generation unit 25, and an output unit 26.

The image acquisition unit 21 acquires captured image data which has been input according to an instruction from the user.

The captured image data to be acquired by the image acquisition unit 21 can be, for example, data directly sent from, for example, a digital camera, data acquired by, for example, a digital camera and then stored in, for example, the HDD 103, or data acquired via a network (not illustrated).

The reference line setting unit 22 sets, as a first line segment, a reference line composed of an aggregate of reference points within an image acquired by the image acquisition unit 21. In the present exemplary embodiment, setting of a reference line serving as a first line segment is performed by the designation of a starting point and an ending point by a user instruction. The details of the reference line and reference point are described below.

The evaluation line calculation unit 23 calculates, as an evaluation line, a second line segment passing through a reference point on the line segment of a reference line set by the reference line setting unit 22, and further calculates an evaluation point on the line segment of the evaluation line. The details of the evaluation line and evaluation point are described below.

The color difference calculation unit 24 performs color difference acquisition processing for calculating color differences between reference points on a reference line and evaluation points on an evaluation line. The details of the color difference acquisition (color difference calculation) processing are described below.

The color-difference map generation unit 25 generates a color-difference map representing a two-dimensional distribution of color differences based on the color differences calculated by the color difference calculation unit 24. The details of the color-difference map generation are described below.

The output unit 26 displays a color-difference map generated by the color-difference map generation unit 25 on the monitor 105.

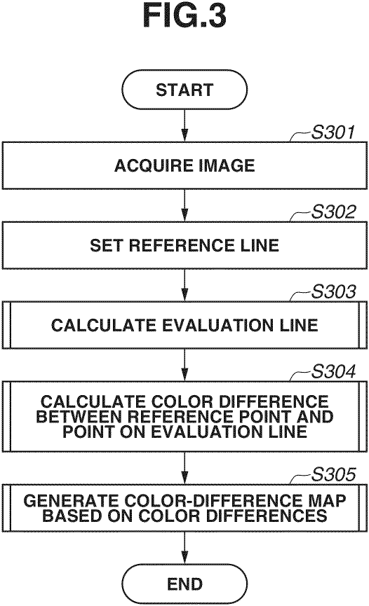

FIG. 3 is a flowchart illustrating the flow of the entirety of information processing which is performed by the information processing apparatus in the first exemplary embodiment. Furthermore, an operation to be described below is started by the user starting an information processing application via the instruction input unit 107 and, then, the user inputting a predetermined instruction to a user interface (UI) described below.

In step S301, the image acquisition unit 21 acquires captured image data.

In step S302, the reference line setting unit 22 sets a reference line.

In step S303, the evaluation line calculation unit 23 calculates an evaluation line relative to a reference point on the reference line by evaluation line calculation processing described below and also calculates an evaluation point on the evaluation line. An evaluation point on the evaluation line is a comparison point serving as a target for comparison in color with a reference point on the reference line.

In step S304, the color difference calculation unit 24 acquires color difference information by color difference calculation processing described below using the reference points and comparison points (evaluation points).

In step S305, the color-difference map generation unit 25 generates a color-difference map by color-difference map generation processing described below using the color difference information. Then, the output unit 26 displays the generated color-difference map on the monitor 105. Then, the information processing apparatus performs processing associated with ending.

### UI in Information Processing Application in First Exemplary Embodiment

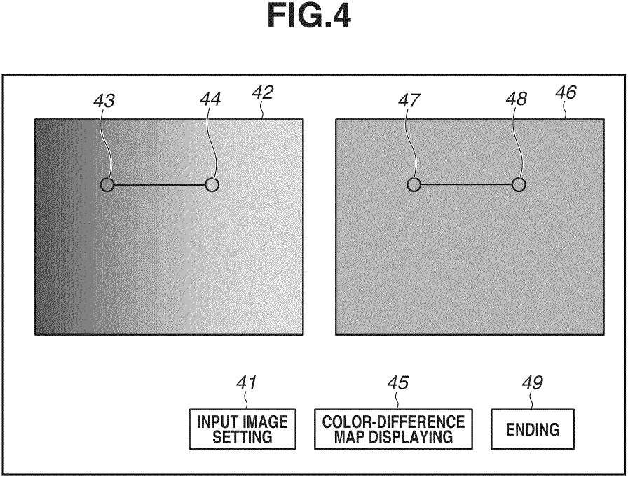

FIG. 4 is a schematic diagram representing a UI in the information processing apparatus in the first exemplary embodiment.

An input image setting button 41 is a button via which the user issues an instruction in performing setting of an input image.

A color-difference map displaying button 45 is a button via which the user issues an instruction in performing color-difference map displaying.

An ending button 49 is a button via which the user issues an instruction in ending the application.

An image display window 42 is a window in which to display an image set by the user issuing an instruction via the input image setting button 41.

A plotted point 43 within the image display window 42 is a plotted point representing a starting point of the reference line and is designated by the user. Moreover, a plotted point 44 is a plotted point representing an ending point of the reference line and is designated by the user. In the first exemplary embodiment, a first line segment with the plotted point 43 and the plotted point 44 set as both end points is set as a reference line.

A color-difference map display window 46 is a window in which to display a color-difference map obtained by color difference acquisition processing (color difference calculation processing) and color-difference map generation processing described below.

A plotted point 47 within the color-difference map display window 46 is a plotted point corresponding to the starting point of the reference line and indicates the same position as that of coordinates designated as the plotted point 43 by the user. A plotted point 48 is a plotted point corresponding to the ending point of the reference line and indicates the same position as that of coordinates designated as the plotted point 44 by the user.

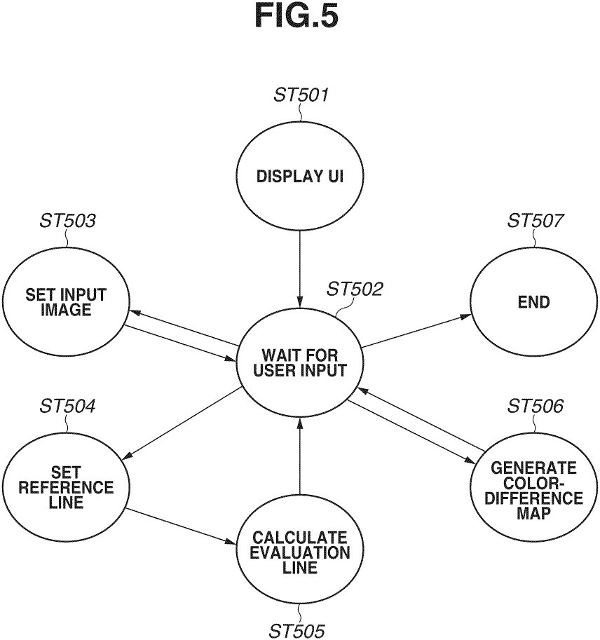

FIG. 5 is a state transition diagram illustrating a state transition in the information processing apparatus corresponding to user inputs to the UI according to the first exemplary embodiment. Furthermore, control of respective state transitions illustrated in the state transition diagram of FIG. 5 and other state transition diagrams described subsequent to that is performed by the CPU 101.

When an application starting instruction is input from the user, the information processing apparatus transitions to a state ST501, in which the information processing apparatus displays the above-mentioned UI on the monitor 105. After the state ST501, the information processing apparatus transitions to a state ST502.

In the state ST502, when the input image setting button 41 is pressed by the user, the information processing apparatus transitions to a state ST503, in which the information processing apparatus reads an image designated by the user and displays the image in the image display window 42. Image designation in the state ST502 and image acquisition in the state ST503 correspond to image acquisition processing in step S301, which is performed by the image acquisition unit 21. When the image acquisition processing in the state ST503 is ended, the information processing apparatus transitions to the state ST502.

Next, in the state ST502, when the plotted point 43 is set within the image display window 42 by the user, the information processing apparatus transitions to a state ST504. Then, in the state ST504, when the plotted point 44 is set by the user, the information processing apparatus acquires coordinate information about an area which is set by the plotted point 43 and the plotted point 44. Thus, a starting point and an ending point of a reference line serving as a first line segment are identified by the coordinate information about an area which is set by the plotted point 43 and the plotted point 44, so that the reference line is set. Acquisition of coordinate information and setting of a line segment in the state ST504 correspond to reference line setting processing in step S302, which is performed by the reference line setting unit 22. When the reference line setting processing in the state ST504 is ended, the information processing apparatus transitions to a state ST505.

Upon transitioning to the state ST505, the information processing apparatus calculates an evaluation line by evaluation line calculation processing. While the details of processing to be performed here are described below, calculation of an evaluation line in the state ST505 corresponds to evaluation line calculation processing in step S303, which is performed by the evaluation line calculation unit 23. Then, when the evaluation line calculation processing in the state ST505 is ended, the information processing apparatus transitions to the state ST502.

Next, in the state ST502, when the color-difference map displaying button 45 is pressed by the user, the information processing apparatus transitions to a state ST506. Then, in the state ST506, the information processing apparatus calculates color differences and performs generation of a color-difference map and displaying of the color-difference map in the color-difference map display window 46. Color difference calculation in the state ST506 corresponds to color difference calculation processing in step S304, which is performed by the color difference calculation unit 24, and generation of a color-difference map in the state ST506 corresponds to color-difference map generation processing in step S305, which is performed by the color-difference map generation unit 25. When processing for the color difference calculation and the color-difference map generation and displaying in the state ST506 is ended, the information processing apparatus transitions to the state ST502.

After that, in the state ST502, when the ending button 49 is pressed by the user instruction, the information processing apparatus transitions to a state ST507, in which the information processing apparatus performs processing associated with ending.

### Evaluation Line Calculation Processing Flow in Step S303

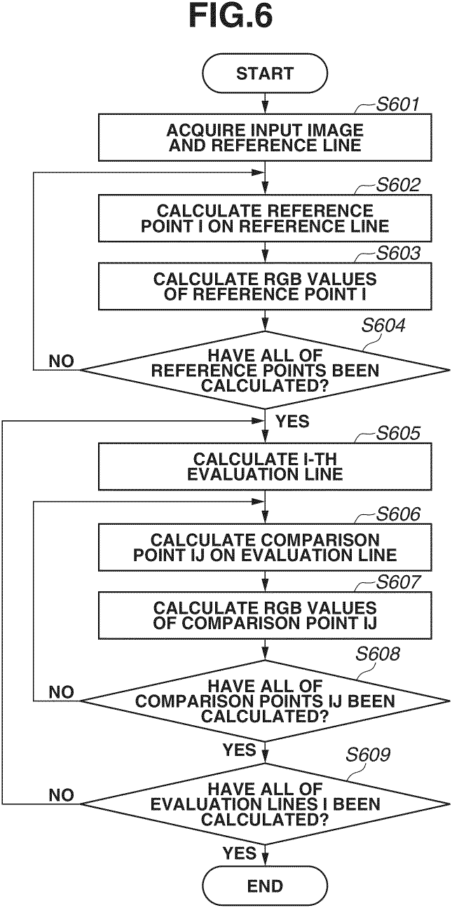

FIG. 6 is a flowchart illustrating the flow of evaluation line calculation processing which is performed by the evaluation line calculation unit 23 of the information processing apparatus according to the first exemplary embodiment.

First, in step S601, the evaluation line calculation unit 23 acquires input image information and reference line information. The reference line information to be acquired at this time is coordinate values (xs, ys) of the plotted point 43 and coordinate values (xe, ye) of the plotted point 44. The coordinate system used here is assumed to be the one with an upper left corner of the input image set as an origin. Furthermore, since, if an input image is directly used, sporadic values may be calculated in calculation of color differences due to noises included in the image, an image obtained by performing moving average of a plurality of pixels can be used.

Next, in step S602, the evaluation line calculation unit 23 calculates a reference point on the reference line. In the present exemplary embodiment, “I” is used as identification information (ID) about a point targeted for calculation on the reference line (a reference point), and the initial value thereof is assumed to be “0”. An example of a calculation formula for determining the total number N of reference points is shown by formula (1). Furthermore, “N” represents a maximum integer value which a numerical value inside a Gauss symbol used in formula (1) does not exceed. Moreover, x- and y-coordinate values (xi, yi) of the reference point I is calculated by use of formulae (2).

$$\begin{matrix}\text{N} = \left⌊\sqrt{{\left(x e - s x\right)}^{2} + {\left(y e - y s\right)}^{2}}\right⌋ \\ \left⌊\right⌋ : \text{Gauss symbol} \left(\text{floor function}\right)\end{matrix}$$

$$\begin{matrix}\text{xi} = \text{xs} + \frac{1}{N} \left(x e - x s\right) \\ \text{yi} = \text{ys} + \frac{1}{N} \left(y e - y s\right)\end{matrix}$$

Next, in step S603, the evaluation line calculation unit 23 calculates red, green, and blue (RGB) values, for three primary colors, in the reference point I. The RGB values of the reference point I (Ri, Gi, Bi) are calculated by use of formulae (3).

$$\begin{matrix}\text{Ri} = \left(1 - \text{yi} + \left⌊y i\right⌋\right) \left(\left(1 - x i + \left⌊x i\right⌋\right) {R}_{\left⌊x i\right⌋ , \left⌊y i\right⌋} + \left(x i - \left⌊x i\right⌋\right) {R}_{\left⌊x i\right⌋ , \left⌊y i\right⌋}\right) \\ + \left(\text{yi} - \left⌊y i\right⌋\right) \left(\left(1 - x i + \left⌊x i\right⌋\right) {R}_{\left⌊x i\right⌋ , \left⌊y i\right⌋} + \left(x i - \left⌊x i\right⌋\right) {R}_{\left⌊x i\right⌋ , \left⌊y i\right⌋}\right) \\ \text{Gi} = \left(1 - \text{yi} + \left⌊y i\right⌋\right) \left(\left(1 - x i + \left⌊x i\right⌋\right) {G}_{\left⌊x i\right⌋ , \left⌊y i\right⌋} + \left(x i - \left⌊x i\right⌋\right) {G}_{\left⌊x i\right⌋ , \left⌊y i\right⌋}\right) \\ + \left(\text{yi} - \left⌊y i\right⌋\right) \left(\left(1 - x i + \left⌊x i\right⌋\right) {G}_{\left⌊x i\right⌋ , \left⌊y i\right⌋} + \left(x i - \left⌊x i\right⌋\right) {G}_{\left⌊x i\right⌋ , \left⌊y i\right⌋}\right) \\ \text{Bi} = \left(1 - \text{yi} + \left⌊y i\right⌋\right) \left(\left(1 - x i + \left⌊x i\right⌋\right) {B}_{\left⌊x i\right⌋ , \left⌊y i\right⌋} + \left(x i - \left⌊x i\right⌋\right) {B}_{\left⌊x i\right⌋ , \left⌊y i\right⌋}\right) \\ + \left(\text{yi} - \left⌊y i\right⌋\right) \left(\left(1 - x i + \left⌊x i\right⌋\right) {B}_{\left⌊x i\right⌋ , \left⌊y i\right⌋} + \left(x i - \left⌊x i\right⌋\right) {B}_{\left⌊x i\right⌋ , \left⌊y i\right⌋}\right)\end{matrix}$$

Next, in step S604, the evaluation line calculation unit 23 determines whether RGB values have been calculated with respect to all of the reference points I, and, if it is determined that all of the reference points I have been calculated (YES in step S604), the evaluation line calculation unit 23 initializes “I” to “0” and advances the processing to step S605 and, if not so (NO in step S604), the evaluation line calculation unit 23 adds “1” to “I” and returns the processing to step S602.

In step S605, the evaluation line calculation unit 23 calculates the I-th evaluation line by formula (4). Here, the I-th evaluation line is assumed to be a straight line passing through the reference point I and is assumed to be, as an example, a straight line perpendicular to the reference line. However, the I-th evaluation line only needs to be a straight line having a point of interconnection with the reference line and passing thorough the reference point I, and is not limited to this example. For example, a line segment passing through the reference point I and parallel to the horizontal direction or vertical direction of an image can be set as an evaluation line.

$$\text{y} = - \frac{x e - x s}{y e - y s} \left(x - x i\right) + y i$$

Next, in step S606, the evaluation line calculation unit 23 calculates a comparison point IJ (evaluation point) on the evaluation line. Here, identification information (ID) about the J-th point on the I-th evaluation line is represented by use of “IJ”, and the respective initial values of “I” and “J” are assumed to be “0”. Moreover, an example of a calculation formula for determining the total number Ni of comparison points on the I-th evaluation line is shown by formula (5). In this respect, intersection points between any two sides of the four sides of an image and the evaluation line are represented by P1(xp1, yp1) and P2(xp2, yp2). Moreover, coordinate values (xij, yij) of the comparison point IJ are calculated by use of formulae (6).

$$\text{Ni} = \left⌊\sqrt{{\left(x p 2 - x p 1\right)}^{2} + {\left(y p 2 - y p 1\right)}^{2}}\right⌋$$

$$\begin{matrix}\text{xij} = \text{xp1} + \frac{1}{N i} \left(x p 2 - x p 1\right) \\ \text{yij} = \text{yp1} + \frac{1}{N i} \left(y p 2 - y p 1\right)\end{matrix}$$

Next, in step S607, the evaluation line calculation unit 23 calculates RGB values of the comparison point IJ. RGB values (Rij, Gij, Bij) of the comparison point IJ are calculated by use of formulae (7).

$$\begin{matrix}\text{Rij} = \left(1 - \text{yij} + \left⌊y i j\right⌋\right) \left(\left(1 - x i j + \left⌊x i j\right⌋\right) {R}_{\left⌊x i j\right⌋ , \left⌊y i j\right⌋} + \left(x i j -\right)\right) \\ \left(\left(\left⌊x i j\right⌋\right) {R}_{\left⌊x i j\right⌋ , \left⌊y i j\right⌋}\right) + \left(\text{yij} - \left⌊y i j\right⌋\right) \left(\left(1 - x i j + \left⌊x i j\right⌋\right) {R}_{\left⌊x i j\right⌋ , \left⌊y i j\right⌋} +\right) \\ \left(\left(x i j - \left⌊x i j\right⌋\right) {R}_{\left⌊x i j\right⌋ , \left⌊y i j\right⌋}\right) \\ \text{Gij} = \left(1 - \text{yij} + \left⌊y i j\right⌋\right) \left(\left(1 - x i j + \left⌊x i j\right⌋\right) {G}_{\left⌊x i j\right⌋ , \left⌊y i j\right⌋} + \left(x i j -\right)\right) \\ \left(\left(\left⌊x i j\right⌋\right) {G}_{\left⌊x i j\right⌋ , \left⌊y i j\right⌋}\right) + \left(\text{yij} - \left⌊y i j\right⌋\right) \left(\left(1 - x i j + \left⌊x i j\right⌋\right) {G}_{\left⌊x i j\right⌋ , \left⌊y i j\right⌋} +\right) \\ \left(\left(x i j - \left⌊x i j\right⌋\right) {G}_{\left⌊x i j\right⌋ , \left⌊y i j\right⌋}\right) \\ \text{Bij} = \left(1 - \text{yij} + \left⌊y i j\right⌋\right) \left(\left(1 - x i j + \left⌊x i j\right⌋\right) {B}_{\left⌊x i j\right⌋ , \left⌊y i j\right⌋} + \left(x i j -\right)\right) \\ \left(\left(\left⌊x i j\right⌋\right) {B}_{\left⌊x i j\right⌋ , \left⌊y i j\right⌋}\right) + \left(\text{yij} - \left⌊y i j\right⌋\right) \left(\left(1 - x i j + \left⌊x i j\right⌋\right) {B}_{\left⌊x i j\right⌋ , \left⌊y i j\right⌋} +\right) \\ \left(\left(x i j - \left⌊x i j\right⌋\right) {B}_{\left⌊x i j\right⌋ , \left⌊y i j\right⌋}\right)\end{matrix}$$

Next, in step S608, the evaluation line calculation unit 23 determines whether processing has been performed with respect to all of the comparison points IJ, and, if it is determined that processing has been performed with respect to all of the comparison points IJ (YES in step S608), the evaluation line calculation unit 23 adds “1” to “I” and advances the processing to step S609 and, if not so (NO in step S608), the evaluation line calculation unit 23 adds “1” to “J” and returns the processing to step S606.

In step S609, the evaluation line calculation unit 23 determines whether processing has been performed with respect to all of the evaluation lines, and, if it is determined that processing has not been performed with respect to all of the evaluation lines (NO in step S609), the evaluation line calculation unit 23 adds “1” to “I” and returns the processing to step S605 and, if it is determined that processing has been performed with respect to all of the evaluation lines (YES in step S609), the evaluation line calculation unit 23 performs processing associated with ending.

### Color Difference Calculation Processing in Step S304

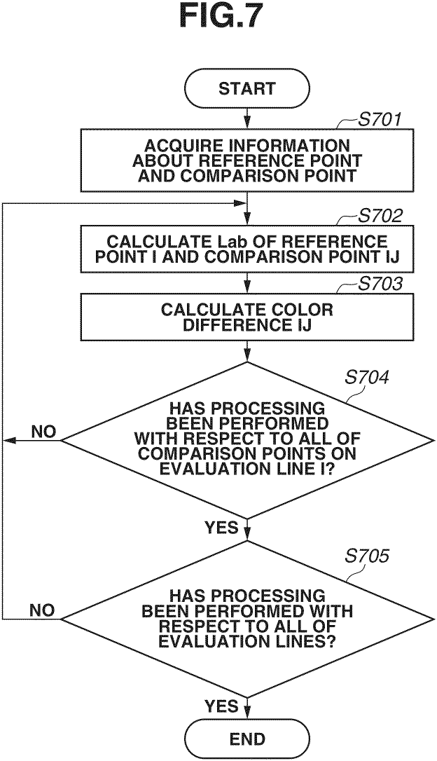

FIG. 7 is a flowchart illustrating the flow of color difference calculation processing which is performed by the color difference calculation unit 24 of the information processing apparatus according to the first exemplary embodiment.

First, in step S701, the color difference calculation unit 24 calculates respective coordinate values and RGB values of the reference point I and the comparison point IJ.

Next, in step S702, the color difference calculation unit 24 calculates “Lab”. Thus, the color difference calculation unit 24 calculates “Lab” from pixel values RGB by use of formulae (8) and formulae (9).

$$\left(\begin{matrix}X \\ Y \\ X\end{matrix}\right) = M \left(\begin{matrix}R \\ G \\ B\end{matrix}\right) , M = \left(\begin{matrix}m 11 & m 12 & m 13 \\ m 21 & m 22 & m 23 \\ m 31 & m 32 & m 33\end{matrix}\right)$$

$$\begin{matrix}\text{L=} 116 ∗ \text{f} \left(\frac{Y}{Y n}\right) - 16 \\ \text{a} = 500 ∗ \left(f \left(\frac{X}{X n}\right) - f \left(\frac{Y}{Y n}\right)\right) \\ \text{b} = 200 ∗ \left(f \left(\frac{Y}{Y n}\right) - f \left(\frac{Z}{Z n}\right)\right) \\ \text{When} \frac{X}{X n} > 0.008856 , f \left(\frac{X}{X n}\right) = {\left(\frac{X}{X n}\right)}^{\frac{1}{3}} , \\ a n d w h e n o t h e r w i s e , f \left(\frac{X}{X n}\right) = 7.787 ∗ \left(\frac{X}{X n}\right) - 16 / 116 \\ \text{When} \frac{Y}{Y n} > 0.008856 , f \left(\frac{Y}{Y n}\right) = {\left(\frac{Y}{Y n}\right)}^{\frac{1}{3}} , \\ a n d w h e n o t h e r w i s e , f \left(\frac{Y}{Y n}\right) = 7.787 ∗ \left(\frac{Y}{Y n}\right) - 16 / 116 \\ \text{When} \frac{Z}{Z n} > 0.008856 , f \left(\frac{Z}{Z n}\right) = {\left(\frac{Z}{Z n}\right)}^{\frac{1}{3}} , \\ a n d w h e n o t h e r w i s e , f \left(\frac{Z}{Z n}\right) = 7.787 ∗ \left(\frac{Z}{Z n}\right) - 16 / 116\end{matrix}$$

Next, in step S703, the color difference calculation unit 24 calculates a color difference. As an example of calculation of the color difference, an example of calculating ΔE in a case where the reference point I is set as C1(L₁, a₁, b₁) and the comparison point IJ is set as C2(L₂, a₂, b₂) is shown by formula (10).

$$Δ \text{E} = \sqrt{{\left({L}_{2 -} {L}_{1}\right)}^{2} + {\left({a}_{2 -} {a}_{1}\right)}^{2} + {\left({b}_{2 -} {b}_{1}\right)}^{2}}$$

Furthermore, instead of ΔE, color difference information on a color space, such as ΔL, Δa, or Δb, can be used.

An example of calculating ΔL is shown by formula (11). Moreover, an example of calculating Δa is shown by formula (12), and an example of calculating Δb is shown by formula (13).

$$Δ \text{L} = {\text{L}}_{2} {\text{- L}}_{1}$$

$$Δ \text{a} = {\text{a}}_{2} {\text{- a}}_{1}$$

$$Δ \text{b} = {\text{b}}_{2} {\text{- b}}_{1}$$

Next, in step S704, the color difference calculation unit 24 determines whether processing has been performed with respect to all of the comparison points on the evaluation line, and, if it is determined that processing has been performed (YES in step S704), the color difference calculation unit 24 advances the processing to step S705 and, if not so (NO in step S704), the color difference calculation unit 24 adds “1” to “J” and returns the processing to step S702.

Next, in step S705, the color difference calculation unit 24 determines whether processing has been performed with respect to all of the evaluation lines, and, if it is determined that processing has not been performed (NO in step S705), the color difference calculation unit 24 adds “1” to “I” and returns the processing to step S702 and, if it is determined that processing has been performed (YES in step S705), the color difference calculation unit 24 performs processing associated with ending.

### Color-Difference Map Generation Processing Flow in Step S305

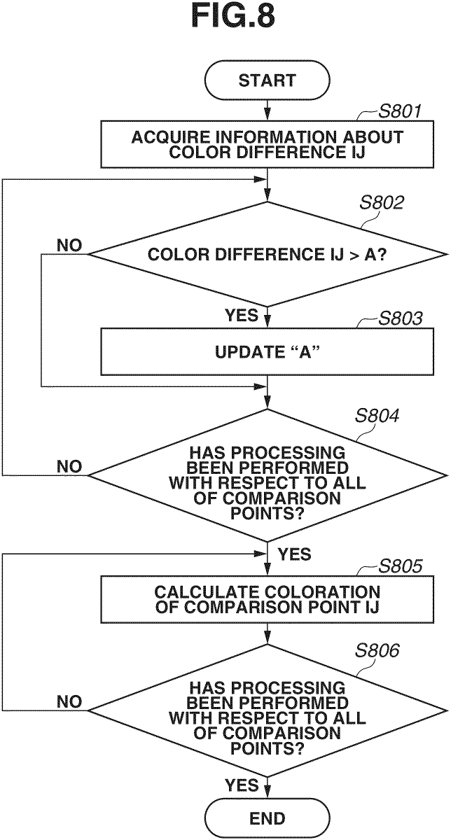

FIG. 8 is a flowchart illustrating the flow of color-difference map generation processing which is performed by the color-difference map generation unit 25 of the information processing apparatus according to the first exemplary embodiment.

First, in step S801, the color-difference map generation unit 25 acquires color difference information which is a color difference of the J-th comparison point IJ on the I-th evaluation line (referred to as a “color difference IJ”).

Next, in step S802, the color-difference map generation unit 25 compares “A” representing a color-difference maximum value with the color difference IJ, and, if it is determined that the color difference IJ is larger than the color-difference maximum value A (YES in step S802), the color-difference map generation unit 25 advances the processing to step S803, and, if not so (NO in step S802), the color-difference map generation unit 25 advances the processing to step S804. Furthermore, the initial value of the color-difference maximum value A is assumed to be “0”.

In step S803, the color-difference map generation unit 25 updates the color-difference maximum value A with color difference information about the color difference IJ, and then advances the processing to step S804.

In step S804, the color-difference map generation unit 25 determines whether processing has been performed with respect to color difference information about all of the color differences IJ, and, if it is determined that processing has been performed (YES in step S804), the color-difference map generation unit 25 advances the processing to step S805, and, if not so (NO in step S804), the color-difference map generation unit 25 returns the processing to step S802.

In step S805, the color-difference map generation unit 25 calculates RGB values in the color-difference map of the comparison point IJ. Here, as an example of a color-difference map, a gray gradation with a color difference “0” set as RGB(0, 0, 0) and the color-difference maximum value set as RGB(255, 255, 255) is described by use of 8-bit color signal values. Calculation of RGB values is performed by use of formula (14). Furthermore, to obtain a visually smooth gradation, non-linear conversion, such as gamma (y) conversion or logarithm (log) conversion, can be used.

$$\text{R} = \text{G} = \text{B} = \left(Δ \text{E/A}\right) \times 255$$

Next, in step S806, the color-difference map generation unit 25 determines whether processing has been performed with respect to all of the comparison points IJ, and, if it is determined that processing has not yet been performed (NO in step S806), the color-difference map generation unit 25 returns the processing to step S805, and, if it is determined that processing has been performed (YES in step S806), the color-difference map generation unit 25 performs processing associated with ending.

As described above, the information processing apparatus in the first exemplary embodiment sets, within an image, an aggregate of reference points in a linear manner as a first line segment (reference line), and further sets an aggregate of evaluation points (comparison points) used for performing color difference calculation with respect to respective reference points as a second line segment (evaluation line). Then, the information processing apparatus in the first exemplary embodiment calculates color differences between the plurality of reference points and the plurality of evaluation points. Thus, according to the first exemplary embodiment, it is possible to generate and display, as a color-difference map, color differences between a plurality of reference points and a plurality of evaluation points designated within an image.

In the first exemplary embodiment, a method of providing a reference line within an input image and automatically setting an evaluation line intersecting with the reference line has been described. On the other hand, at the scene of execution of a color inspection, controlling the vector of an evaluation line independently of a reference line may be requested due to the relationship of an illuminance distribution caused by illumination. Therefore, in a second exemplary embodiment, a method of performing setting of an evaluation line in addition to setting of a reference line and generating a color-difference map based on respective pieces of information about reference points on the set reference line and evaluation points (comparison points) on the set evaluation line is described. Furthermore, in the second exemplary embodiment, only constituent elements and processing operations different from those in the first exemplary embodiment are described. The hardware configuration of an information processing apparatus according to the second exemplary embodiment is similar to the configuration illustrated in FIG. 1 and is, therefore, omitted from illustration and description.

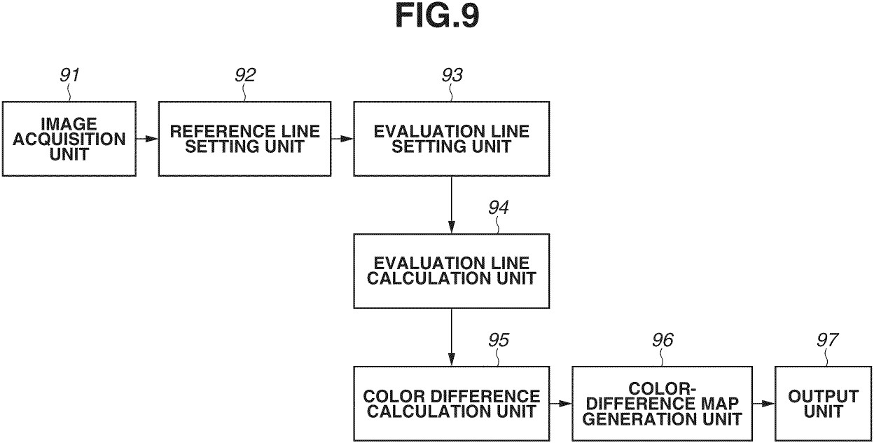

FIG. 9 is a diagram illustrating a logical configuration of the information processing apparatus according to the second exemplary embodiment.

The information processing apparatus in the second exemplary embodiment includes an image acquisition unit 91, a reference line setting unit 92, an evaluation line setting unit 93, an evaluation line calculation unit 94, a color difference calculation unit 95, a color-difference map generation unit 96, and an output unit 97.

The image acquisition unit 91 acquires captured image data which has been input according to a user instruction.

The reference line setting unit 92 sets, as a first line segment, a reference line composed of an aggregate of reference points within an image acquired by the image acquisition unit 91. As with the first exemplary embodiment, setting of a reference line (first line segment) is performed by the designation of a starting point and an ending point by a user instruction. The details of reference line setting processing in the second exemplary embodiment are described below.

The evaluation line setting unit 93 sets, as a second line segment, an evaluation line composed of an aggregate of evaluation points (comparison points) within an image acquired by the image acquisition unit 91. In the case of the second exemplary embodiment, setting of an evaluation line (second line segment) is performed by the designation of a starting point and an ending point by a user instruction. The details of evaluation line setting processing in the second exemplary embodiment are described below.

The evaluation line calculation unit 94 calculates a line passing through a reference point on the reference line and being parallel to the evaluation line and additionally calculates an evaluation point on the calculated line. The details of evaluation line calculation processing in the second exemplary embodiment are described below.

The color difference calculation unit 95 calculates a color difference between the reference point and the evaluation point on the line.

The color-difference map generation unit 96 generates a color-difference map based on the calculated color differences.

The output unit 97 performs displaying of the generated color-difference map.

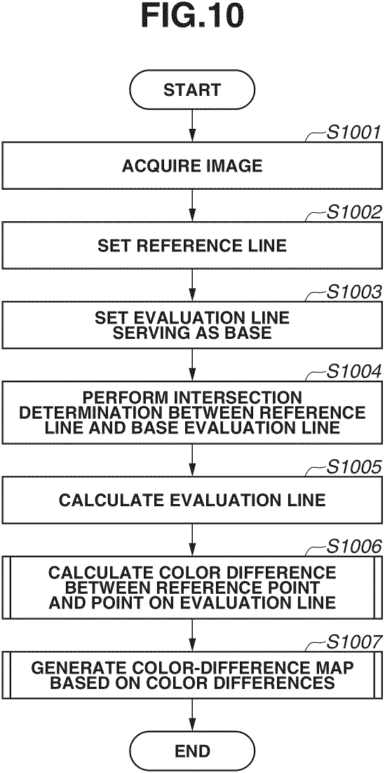

FIG. 10 is a flowchart illustrating the flow of the entirety of information processing which is performed by the information processing apparatus in the second exemplary embodiment. Furthermore, an operation to be described below is started by the user starting an information processing application and, then, the user inputting a predetermined instruction to a user interface (UI) described below.

In step S1001, the image acquisition unit 91 acquires captured image data.

In step S1002, the reference line setting unit 92 sets a reference line.

In step S1003, the evaluation line setting unit 93 sets an evaluation line serving as a base (in the present exemplary embodiment, referred to as a “base evaluation line”).

In step S1004, the evaluation line calculation unit 94 performs intersection determination between the reference line and the base evaluation line. Here, the determination formula for the intersection determination between the reference line and the base evaluation line is the following formulae (15). In step S1004, if the determination result E in formulae (15) satisfies the condition, the evaluation line calculation unit 94 determines that the reference line and the base evaluation line intersect with each other and, if not so, the evaluation line calculation unit 94 determines that the reference line and the base evaluation line do not intersect with each other, so that, if it is determined that the reference line and the base evaluation line do not intersect with each other, the evaluation line calculation unit 94 returns the processing to step S1003, in which the evaluation line setting unit 93 sets a base evaluation line again. In this respect, the coordinate values of a starting point of the reference line is assumed to be (xs, ys), the coordinate values of an ending point of the reference line is assumed to be (xe, ye), the coordinate values of a starting point of the base evaluation line is assumed to be (xp1, yp1), and the coordinate values of an ending point of the base evaluation line is assumed to be (xp2, yp2).

$$\begin{matrix}\text{e1} = \left(\left(\text{xe - xs}\right) \left(\text{yp1 - ys}\right) \text{-} \left(\text{ye - ys}\right) \left(\text{xp1 - xs}\right)\right) \\ \left(\left(\text{xe - xs}\right) \left(\text{yp2 - ys}\right) \text{-} \left(\text{ye - ys}\right) \left(\text{xp2 - xs}\right)\right) < 0 \\ \text{e2} = \left(\left(\text{xp2 - xp1}\right) \left(\text{ys - yp1}\right) \text{-} \left(\text{yp2 - yp1}\right) \left(\text{xs - xp1}\right)\right) \\ \left(\left(\text{xp2 - xp1}\right) \left(\text{ye - yp1}\right) \text{-} \left(\text{yp2 - yp1}\right) \left(\text{xe - xp1}\right)\right) < 0 \\ \text{E} = \text{e1} ∩ \text{e2}\end{matrix}$$

Next, in step S1005, the evaluation line calculation unit 94 calculates a line segment parallel to the base evaluation line set in step S1003 as an evaluation line related to a reference point on the reference line. The evaluation line to be calculated here is able to be represented by the following formula (16) with the coordinate values of the reference point denoted by (xi, yi). Moreover, in step S1005, the evaluation line calculation unit 94 calculates an evaluation point (comparison point) similar to that in the first exemplary embodiment on each evaluation line concurrently with calculation of the evaluation line.

$$\text{y} = \frac{y p 2 - y p 1}{x p 2 - x p 1} \left(x - x i\right) + y i$$

Next, in step S1006, the color difference calculation unit 95 calculates color difference information by performing color difference calculation processing similar to that described in step S304 in the first exemplary embodiment.

Then, in step S1007, the color-difference map generation unit 96 generates a color-difference map by performing color-difference map generation processing similar to that described in step S305 in the first exemplary embodiment. Then, the output unit 97 displays the generated color-difference map on the monitor 105. Then, the information processing apparatus performs processing associated with ending.

### UI in Information Processing Application in Second Exemplary Embodiment

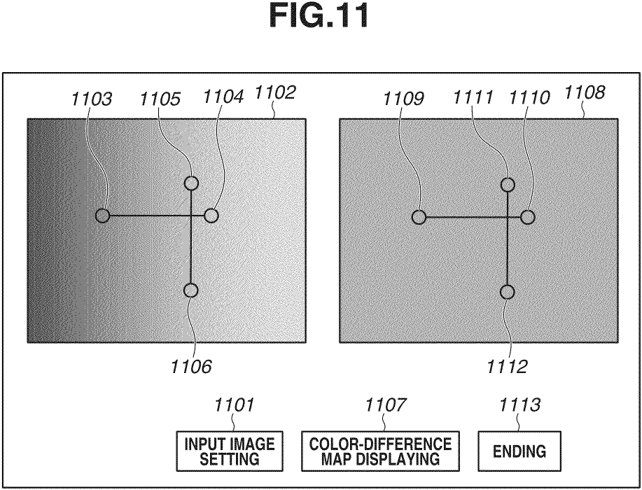

FIG. 11 is a schematic diagram representing a UI in the second exemplary embodiment.

An input image setting button 1101 is a button via which the user issues an instruction in performing setting of an input image.

A color-difference map displaying button 1107 is a button via which the user issues an instruction in performing color-difference map displaying.

An ending button 1113 is a button for ending the application, which is operated by the user.

An image display window 1102 is a window in which to display an image set via the input image setting button 1101. A plotted point 1103 within the image display window 1102 is a plotted point representing a starting point of the reference line and a plotted point 1104 is a plotted point representing an ending point of the reference line, each of which is designated by the user. A plotted point 1105 is a plotted point representing a starting point of the base evaluation line and a plotted point 1106 is a plotted point representing an ending point of the base evaluation line, each of which is designated by the user.

A color-difference map display window 1108 is a window in which to display the calculated color-difference map. A plotted point 1109 within the color-difference map display window 1108 is a plotted point representing a starting point of the reference line, which indicates the same position as that of coordinates designated as the plotted point 1103 by the user.

A plotted point 1110 is a plotted point representing an ending point of the reference line, which indicates the same position as that of coordinates designated as the plotted point 1104 by the user. A plotted point 1111 is a plotted point representing a starting point of the evaluation line, which indicates the same position as that of coordinates designated as the plotted point 1105 by the user. A plotted point 1112 is a plotted point representing an ending point of the evaluation line, which indicates the same position as that of coordinates designated as the plotted point 1106 by the user. Furthermore, while the plotted points 1111 and 1112 are assumed to be plotted points indicating the same positions as those of the plotted points 1105 and 1106 designated by the user, plotted points indicating the positions of a starting point and an ending point of the evaluation line calculated by the evaluation line calculation unit 94 can be displayed.

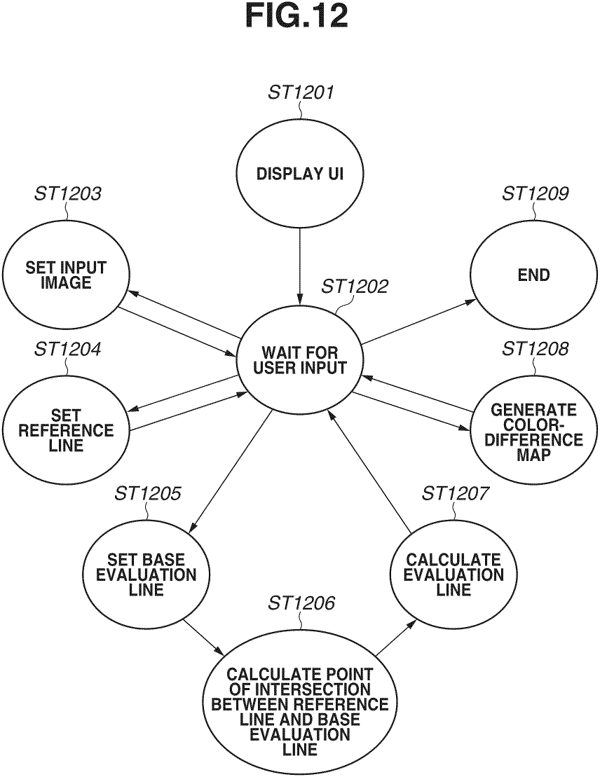

FIG. 12 illustrates a state transition in the information processing apparatus corresponding to user inputs to the UI according to the second exemplary embodiment.

When an application starting instruction is input from the user, the information processing apparatus transitions to a state ST1201, in which the information processing apparatus displays a UI on the monitor 105. After the state ST1201, the information processing apparatus transitions to a state ST1202.

In the state ST1202, when the input image setting button 1101 is pressed by the user, the information processing apparatus transitions to a state ST1203, in which the information processing apparatus reads an image designated by the user and displays the image in the image display window 1102. Image acquisition in the state ST1203 corresponds to image acquisition processing in step S1001, which is performed by the image acquisition unit 91. After the state ST1203, the information processing apparatus transitions to the state ST1202.

Next, in the state ST1202, when the plotted point 1103 is set within the image display window 1102, the information processing apparatus transitions to a state ST1204. Then, in the state ST1204, when the plotted point 1104 is also set, the information processing apparatus acquires coordinate information about an area which is set by the plotted point 1103 and the plotted point 1104. Thus, a starting point and an ending point of a reference line serving as a first line segment are identified, so that the reference line is set. Acquisition of coordinate information and setting of a line segment in the state ST1204 correspond to reference line setting processing in step S1002, which is performed by the reference line setting unit 92. When the reference line setting processing in the state ST1204 is ended, the information processing apparatus transitions to the state ST1202.

Additionally, in the state ST1202, when the plotted point 1105 is set within the image display window 1102, the information processing apparatus transitions to a state ST1205. Then, in the state ST1205, when the plotted point 1106 is also set, the information processing apparatus acquires coordinate information about an area which is set by the plotted point 1105 and the plotted point 1106 as coordinate information about a starting point and an ending point of a line segment serving as a base evaluation line. Thus, the base evaluation line is set. Acquisition of coordinate information and setting of a line segment in the state ST1205 correspond to base evaluation line setting processing in step S1003, which is performed by the evaluation line setting unit 93. When the base evaluation line setting processing in the state ST1205 is ended, the information processing apparatus transitions to a state ST1206.

Upon transitioning to the state ST1206, the information processing apparatus calculates a point of intersection between the reference line and the base evaluation line. Calculation processing of the intersection point in the state ST1206 corresponds to the above-mentioned intersection determination processing in step S1004, which is performed by the evaluation line calculation unit 94. When the intersection determination procssing in the state ST1206 is ended, the information processing apparatus transitions to a state ST1207.

Upon transitioning to the state ST1207, the information processing apparatus calculates an evaluation line, and further calculates an evaluation point (comparison point) on the evaluation line. Evaluation line calculation and evaluation point calculation in the state ST1207 correspond to the above-mentioned evaluation line calculation processing in step S1005, which is performed by the evaluation line calculation unit 94. After the state ST1207, the information processing apparatus transitions to the state ST1202.

Next, in the state ST1202, when the color-difference map displaying button 1107 is pressed by the user, the information processing apparatus transitions to a state ST1208. Then, in the state ST1208, the information processing apparatus performs generation of a color-difference map and displaying of the color-difference map in the color-difference map display window 1108. Processing in the state ST1208 corresponds to color difference calculation processing in step S 1006, which is performed by the color difference calculation unit 95, and color-difference map generation processing and color-difference map displaying processing in step S1007, which are performed by the color-difference map generation unit 96 and the output unit 97, respectively. After the state ST1208, the information processing apparatus transitions to the state ST1202.

After that, in the state ST1202, when the ending button 1113 is pressed by the user, the information processing apparatus transitions to a state ST1209, in which the information processing apparatus performs processing associated with ending.

As described above, the information processing apparatus in the second exemplary embodiment sets, within an image, a reference line and a base evaluation line, performs intersection determination between the reference line and the base evaluation line, and calculates an evaluation line based on a result of the intersection determination. Then, the information processing apparatus in the second exemplary embodiment calculates color differences between a plurality of reference points and a plurality of evaluation points (comparison points) on the set reference line and the calculated evaluation line, thus generating a color-difference map. Thus, according to the information processing apparatus in the second exemplary embodiment, it becomes possible to set a reference line and an evaluation line independently of each other and generate a color-difference map related to a plurality of reference points.

In the second exemplary embodiment, an example of setting a reference line and an evaluation line independent of each other and generating a color-difference map related to a plurality of reference points has been described. However, in this case, depending on manners of setting an evaluation line, a color-difference map for an originally unnecessary area may be generated, so that there is a possibility of becoming time-consuming on the whole processing. Therefore, in a third exemplary embodiment, a method of, instead of setting an independent evaluation line within an image, setting a rectangle within an image and setting an evaluation direction in color difference calculation based on the rectangle, thus enabling generating a minimum necessary color-difference map, is described. Furthermore, even in the third exemplary embodiment, only constituent elements and processing operations different from those in the first and second exemplary embodiments are described. The hardware configuration of an information processing apparatus according to the third exemplary embodiment is similar to the configuration illustrated in FIG. 1 and is, therefore, omitted from illustration and description.

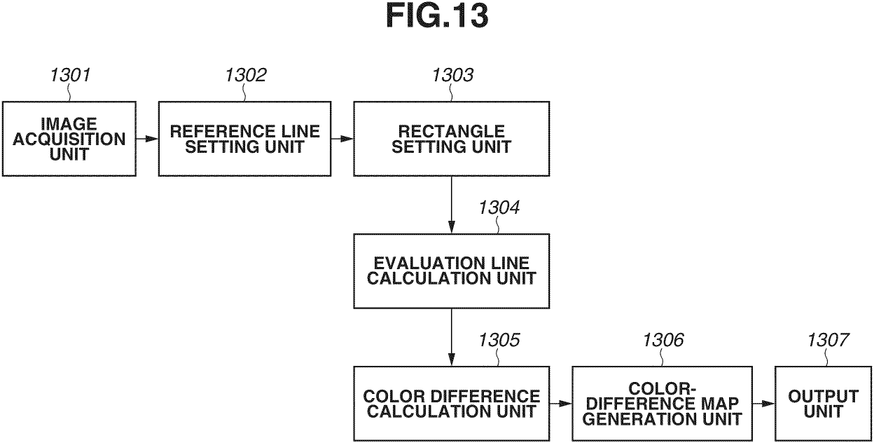

FIG. 13 is a diagram illustrating a logical configuration of the information processing apparatus according to the third exemplary embodiment. The information processing apparatus in the third exemplary embodiment includes an image acquisition unit 1301, a reference line setting unit 1302, a rectangle setting unit 1303, an evaluation line calculation unit 1304, a color difference calculation unit 1305, a color-difference map generation unit 1306, and an output unit 1307.

The image acquisition unit 1301 acquires captured image data which has been input according to a user instruction.

The reference line setting unit 1302 sets a reference line composed of an aggregate of reference points within an image acquired by the image acquisition unit 1301.

The rectangle setting unit 1303 sets, within an image acquired by the image acquisition unit 1301, a rectangle for determining an evaluation direction of color differences related to a reference line in color difference calculation and color-difference map generation. In the case of the present exemplary embodiment, while an independent evaluation line is not set, an evaluation direction of color differences related to a reference line is set by the rectangle. The rectangle is set as a rectangle with a first vertex and a second vertex designated by a user instruction set as opposite vertices. Furthermore, in the third exemplary embodiment, while, in a case where the vertical direction and horizontal direction of a rectangle coincide with the vertical direction and horizontal direction of an image, the evaluation direction of color differences becomes the vertical direction or horizontal direction of the image, the evaluation direction of color differences does not need to be limited to the vertical direction or horizontal direction of the image. For example, in the case of setting the evaluation direction of color differences to a direction different from the vertical direction or horizontal direction of the image, setting a rectangle by, for example, rotating the rectangle relative to the image enables setting a desired direction as the evaluation direction of color differences.

The evaluation line calculation unit 1304 calculates a line passing through a reference point on the reference line and being parallel to the horizontal direction or vertical direction of the rectangle and additionally calculates a point on the calculated line as an evaluation point (comparison point). The direction of the line parallel to the horizontal direction or vertical direction of the rectangle is equivalent to the evaluation direction of color differences, and, in the present exemplary embodiment, the line parallel to the horizontal direction or vertical direction of the rectangle is used as an evaluation line.

The color difference calculation unit 1305 calculates a color difference between the reference point and the evaluation point (comparison point) on the evaluation line.

The color-difference map generation unit 1306 generates a color-difference map based on the calculated color differences.

The output unit 1307 performs displaying of the generated color-difference map.

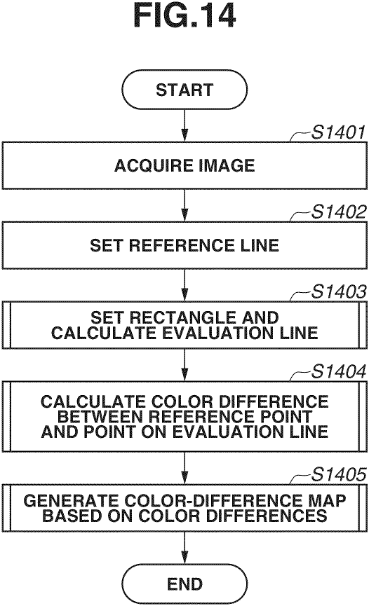

FIG. 14 is a flowchart illustrating the flow of the entirety of information processing which is performed by the information processing apparatus in the third exemplary embodiment. Furthermore, an operation to be described below is started by the user starting an information processing application and, then, the user inputting a predetermined instruction to a user interface (UI) described below.

In step S1401, the image acquisition unit 1301 acquires captured image data.

In step S1402, the reference line setting unit 1302 sets a reference line.

In step S1403, the rectangle setting unit 1303 sets a rectangle and the evaluation line calculation unit 1304 sets an evaluation line. In the case of the present exemplary embodiment, the evaluation line calculation unit 1304 calculates an evaluation line related to a reference point on the reference line by processing described below based on the rectangle set by the rectangle setting unit 1303 and also calculates a comparison point on the evaluation line.

In step S1404, the color difference calculation unit 1305 calculates color difference information by performing color difference calculation processing similar to that described in step S304 in the first exemplary embodiment.

In step S1405, the color-difference map generation unit 1306 generates a color-difference map by performing processing similar to that described in step S305 in the first exemplary embodiment. Then, the output unit 1307 displays the generated color-difference map on the monitor 105. Then, the information processing apparatus performs processing associated with ending.

### UI in Information Processing Application in Third Exemplary Embodiment

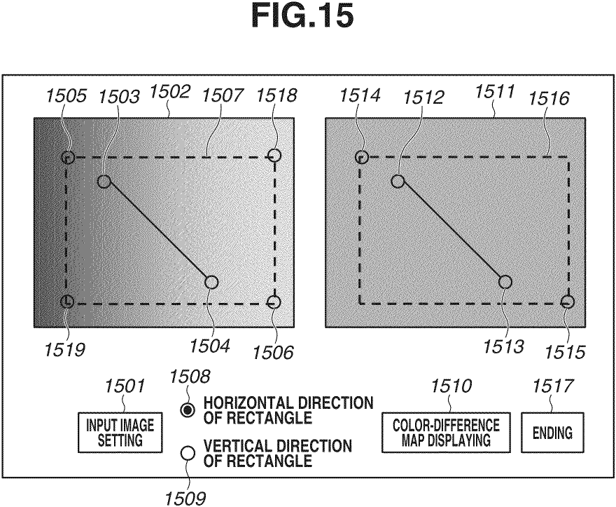

FIG. 15 is a schematic diagram representing a UI in the third exemplary embodiment.

An input image setting button 1501 is a button via which the user issues an instruction in performing setting of an input image.

A radio button 1508 is a button which the user selects in setting the evaluation direction of color differences to the horizontal direction of the rectangle. A radio button 1509 is a button which the user selects in setting the evaluation direction of color differences to the vertical direction of the rectangle.

A color-difference map displaying button 1510 is a button via which the user issues an instruction in performing color-difference map displaying.

An ending button 1517 is a button via which the user issues an instruction in ending the application.

An image display window 1502 is a window in which to display an image set via the input image setting button 1501. A plotted point 1503 is a plotted point representing a starting point of the reference line and a plotted point 1504 is a plotted point representing an ending point of the reference line, each of which is designated by the user. A plotted point 1505 is a plotted point representing a first vertex of the rectangle and a plotted point 1506 is a plotted point representing a second vertex of the rectangle, each of which is designated by the user. The rectangle 1507 is set as a rectangle expressed by a dashed line with the plotted point 1505 and the plotted point 1506 set as opposite vertices. Furthermore, a plotted point 1518 represents a third vertex of the rectangle and a plotted point 1519 represents a fourth vertex of the rectangle. However, since the rectangle is determined by setting of opposite vertices of the rectangle, i.e., the plotted point 1505 (first vertex) and the plotted point 1506 (second vertex), the plotted point 1518 (third vertex) and the plotted point 1519 (fourth vertex) are not determined by the user designation but are automatically determined depending on setting of the rectangle. Moreover, in response to any one vertex of the first vertex to the fourth vertex being designated by the user and, then, an instruction for, for example, rotation being issued, the rectangle 1507 is made able to be rotated within an image displayed in the image display window 1502.

A color-difference map display window 1511 is a window in which to display the calculated color-difference map. A plotted point 1512 is a plotted point representing a starting point of the reference line and indicates the same position as that of coordinates designated as the plotted point 1503 by the user. A plotted point 1513 is a plotted point representing an ending point of the reference line and indicates the same position as that of coordinates designated as the plotted point 1504 by the user. A plotted point 1514 is a plotted point representing a first vertex of the rectangle and indicates the same position as that of coordinates designated as the plotted point 1505 by the user. A plotted point 1515 is a plotted point representing a second vertex of the rectangle and indicates the same position as that of coordinates designated as the plotted point 1506 by the user. The rectangle 1516 is set as a rectangle having the same position as that of coordinates of the rectangle 1507 with the plotted point 1505 and the plotted point 1506 set as opposite vertices. Furthermore, in a case where the rectangle 1507 is set as a rectangle which has been rotated within an image as mentioned above, the rectangle 1516 also becomes a rectangle which has been rotated in a similar way.

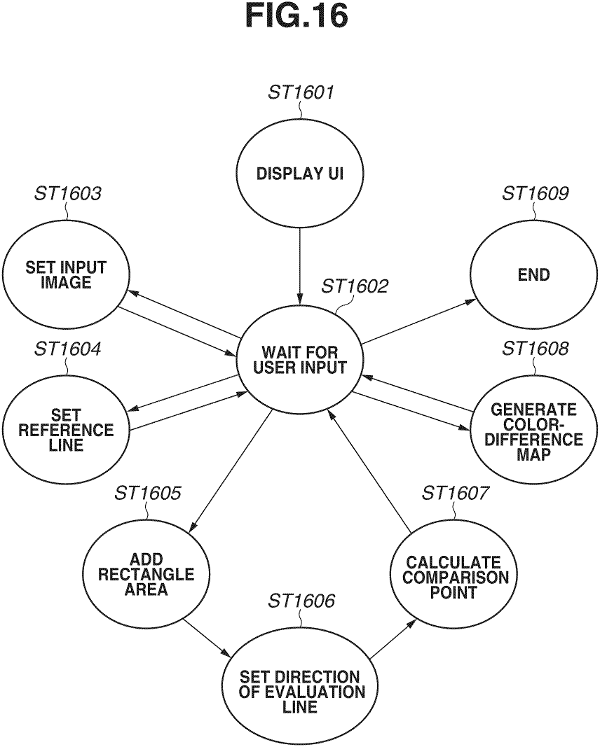

FIG. 16 illustrates a state transition in the information processing apparatus corresponding to user inputs to the UI according to the third exemplary embodiment.

When an application starting instruction is input from the user, the information processing apparatus transitions to a state ST1601, in which the information processing apparatus displays a UI on the monitor 105. After the state ST1601, the information processing apparatus transitions to a state ST1602.

In the state ST1602, when the input image setting button 1501 is pressed by the user, the information processing apparatus transitions to a state ST1603, in which the information processing apparatus reads an image designated by the user and displays the image in the image display window 1502. Image acquisition in the state ST1603 corresponds to image acquisition processing in step S1401, which is performed by the image acquisition unit 1301. After the state ST1603, the information processing apparatus transitions to the state ST1602.

Next, in the state ST1602, when the plotted point 1503 is set within the image display window 1502, the information processing apparatus transitions to a state ST1604. Then, in the state ST1604, when the plotted point 1504 is also set, the information processing apparatus acquires coordinate information about an area which is set by the plotted point 1503 and the plotted point 1504. Accordingly, a reference line serving as a first line segment is set. Acquisition of coordinate information and setting of a line segment in the state ST1604 correspond to reference line setting processing in step S1402, which is performed by the reference line setting unit 1302. When the reference line setting processing in the state ST1604 is ended, the information processing apparatus transitions to the state ST1602.

Additionally, in the state ST1602, when the plotted point 1505 is set within the image display window 1502, the information processing apparatus transitions to a state ST1605. Then, in the state ST1605, when the plotted point 1506 is also set, the information processing apparatus acquires coordinate information about a rectangle with the plotted point 1505 set as a first vertex and the plotted point 1506 set as a second vertex, and then transitions to a state ST1606.

Upon transitioning to the state ST1606, the information processing apparatus sets the direction of an evaluation line (i.e., the evaluation direction of color differences) based on the rectangle. Here, for example, in a case where the radio button 1508 is currently set, the horizontal direction of the rectangle is set as the direction of an evaluation line, and, on the other hand, in a case where the radio button 1509 is currently set, the vertical direction of the rectangle is set as the direction of an evaluation line. After the direction of an evaluation line (the evaluation direction of color differences) is set in the state ST1606, the information processing apparatus transitions to a state ST1607. Then, in the state ST1607, the information processing apparatus calculates a comparison point on the evaluation line, and then transitions to the state ST1602. These processing operations in the state ST1605 to the state ST1607 correspond to rectangle setting processing, which is performed by the rectangle setting unit 1303, and evaluation line calculation processing, which is performed by the evaluation line calculation unit 1304, in step S1403.

Next, in the state ST1602, when the color-difference map displaying button 1510 is pressed by the user, the information processing apparatus transitions to a state ST1608. Then, in the state ST1608, the information processing apparatus generates a color-difference map and then displays the color-difference map in the color-difference map display window 1511. This processing in the state ST1608 corresponds to color difference calculation processing, which is performed by the color difference calculation unit 1305, in step S1404 and color-difference map generation processing, which is performed by the color-difference map generation unit 1306, in step S1405. After the state ST1608, the information processing apparatus transitions to the state ST1602.

After that, in the state ST1602, when the ending button 1517 is pressed by the user, the information processing apparatus transitions to a state ST1609, in which the information processing apparatus performs processing associated with ending.

### Evaluation Line Calculation Processing Flow in Step S1403

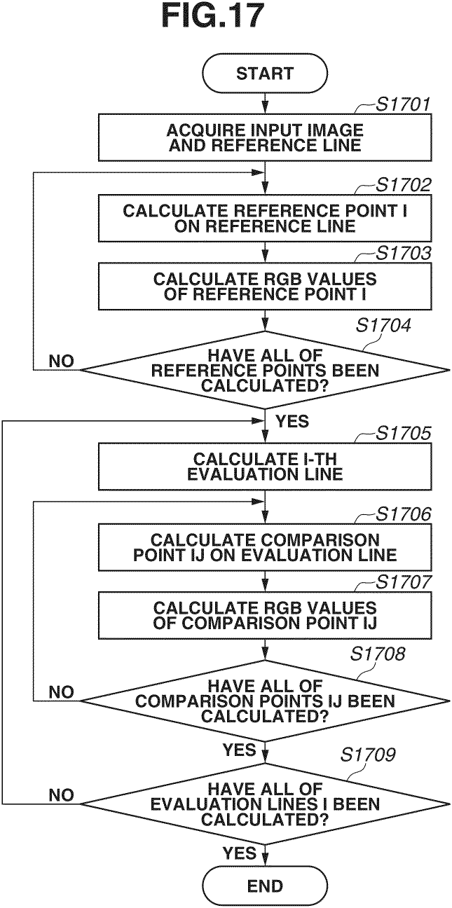

FIG. 17 is a flowchart illustrating the flow of evaluation line calculation processing which is performed by the evaluation line calculation unit 1304 of the information processing apparatus according to the third exemplary embodiment.

First, in step S1701, the evaluation line calculation unit 1304 acquires input image information and reference line information. The reference line information to be acquired at this time is coordinate values (xs, ys) of the plotted point 1503 and coordinate values (xe, ye) of the plotted point 1504.

Next, in step S1702, the evaluation line calculation unit 1304 calculates a reference point on the reference line with use of the above-mentioned formula (1), and further calculates coordinate values (xi, yi) of the reference point I with use of the above-mentioned formulae (2).

Next, in step S1703, the evaluation line calculation unit 1304 calculates RGB values of the reference point I. The RGB values of the reference point I (Ri, Gi, Bi) are calculated by use of the above-mentioned formulae (3).

Next, in step S1704, the evaluation line calculation unit 1304 determines whether RGB values have been calculated with respect to all of the reference points I, and, if it is determined that all of the reference points I have been calculated (YES in step S1704), the evaluation line calculation unit 1304 initializes “I” to “0” and advances the processing to step S1705 and, if not so (NO in step S1704), the evaluation line calculation unit 1304 adds “1” to “I” and returns the processing to step S1702.

In step S1705, the evaluation line calculation unit 1304 calculates the I-th evaluation line. The direction of the evaluation line is acquired as a direction corresponding to a result of the user selection of the radio button 1508 or the radio button 1509 out of the horizontal direction and vertical direction of the rectangle.

In a case where the direction of an evaluation line is currently set as the horizontal direction of the rectangle, the evaluation line is expressed by formula (17). Moreover, in a case where the direction of an evaluation line is currently set as the vertical direction of the rectangle, the evaluation line is expressed by formula (18). Here, the coordinates of the plotted point 1506 are assumed to be (xp1, yp1), the coordinates of the plotted point 1518 are assumed to be (xp2, yp2), and the coordinates of the plotted point 1519 are assumed to be (xp3, yp3).

$$\text{y} = - \frac{x p 2 - x p 1}{y p 2 - y p 1} \left(x - x i\right) + y i$$

$$\text{y} = - \frac{x p 3 - x p 1}{y p 3 - y p 1} \left(x - x i\right) + y i$$

Furthermore, in a case where, when intersection determination between the reference line and the evaluation line is performed, the setting direction indicates that the reference line and the evaluation line do not intersect with each other, the direction of the evaluation line is changed to a direction intersecting with the reference line.

Next, in step S1706, the evaluation line calculation unit 1304 calculates a comparison point IJ on the evaluation line. Furthermore, the J-th point on the I-th evaluation line is expressed as a comparison point IJ.

Here, in a case where the direction of the evaluation line is the horizontal direction of the rectangle, the coordinate values (xij, yij) of the comparison point IJ are calculated by use of formulae (19). On the other hand, in a case where the direction of the evaluation line is the vertical direction of the rectangle, the coordinate values (xij, yij) of the comparison point IJ are calculated by use of formulae (20).

$$\begin{matrix}\text{xij} = \text{xp1} + \frac{J}{N} \left(x p 3 - x p 1\right) \\ \text{yij} = \text{yi}\end{matrix}$$

$$\begin{matrix}\text{xij} = \text{xi} \\ \text{yij} = \text{yp1} + \frac{J}{N} \left(y p 2 - y p 1\right)\end{matrix}$$

Next, in step S1707, the evaluation line calculation unit 1304 calculates RGB values of the comparison point IJ. RGB values (Rij, Gij, Bij) of the comparison point IJ are calculated by use of the above-mentioned formulae (7).

Next, in step S1708, the evaluation line calculation unit 1304 determines whether processing has been performed with respect to all of the comparison points IJ, and, if it is determined that processing has been performed with respect to all of the comparison points IJ (YES in step S1708), the evaluation line calculation unit 1304 adds “1” to “I” and advances the processing to step S1709 and, if not so (NO in step S1708), the evaluation line calculation unit 1304 adds “1” to “J” and returns the processing to step S1706.

In step S1709, the evaluation line calculation unit 1304 determines whether processing has been performed with respect to all of the evaluation lines, and, if it is determined that processing has not been performed with respect to all of the evaluation lines (NO in step S1709), the evaluation line calculation unit 1304 adds “1” to “I” and returns the processing to step S1705 and, if it is determined that processing has been performed with respect to all of the evaluation lines (YES in step S1709), the evaluation line calculation unit 1304 performs processing associated with ending.

As described above, the information processing apparatus in the third exemplary embodiment sets the evaluation direction of color differences (the direction of the evaluation line) based on a rectangle. Thus, according to the information processing apparatus in the third exemplary embodiment, it becomes possible to generate a minimum necessary color-difference map, thus reducing processing time.

In the above-described exemplary embodiments, a method of setting an aggregate of reference points with use of one straight line has been described. On the other hand, if a subject has a three-dimensional shape or the illumination distribution is inhomogeneous, the aggregate of reference points may become not a straight line but a curved aggregate. In a case where the aggregate of reference points has such a curved distribution, the method employed in the above-described exemplary embodiments may become unable to effectively function. Therefore, in a fourth exemplary embodiment, a method of effectively setting a reference line even in a case where the aggregate of reference points has a non-linear distribution is described. Furthermore, even in the fourth exemplary embodiment, only constituent elements and processing operations different from those in the above-described exemplary embodiments are described. The hardware configuration of an information processing apparatus according to the fourth exemplary embodiment is similar to the configuration illustrated in FIG. 1 and is, therefore, omitted from illustration and description.

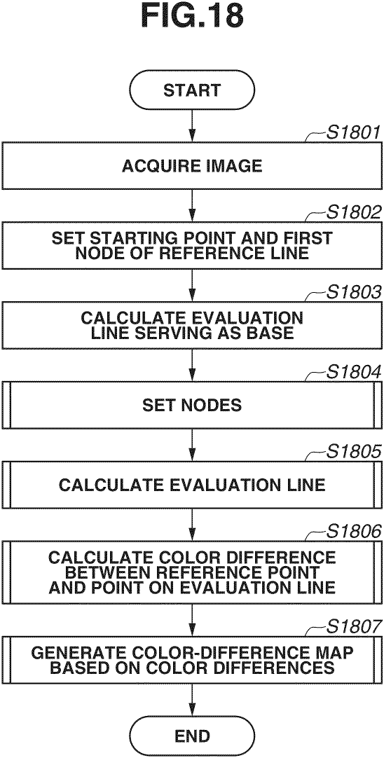

FIG. 18 is a flowchart illustrating the flow of information processing which is performed by the information processing apparatus in the fourth exemplary embodiment. Furthermore, a logical configuration of the information processing apparatus in the fourth exemplary embodiment is the same as that described with reference to FIG. 2 in the first exemplary embodiment. However, in the case of the information processing apparatus in the fourth exemplary embodiment, processing in the reference line setting unit 22 and the evaluation line calculation unit 23 is different from the processing in the first exemplary embodiment. An operation to be described below is started by the user starting an information processing application and, then, the user inputting a predetermined instruction to a user interface (UI) described below.

In step S1801, the image acquisition unit 21 acquires captured image data.

In step S1802, the reference line setting unit 22 sets a starting point and a first node of the reference line. Furthermore, the details of setting of each of the first node and second and subsequent nodes are described below.

In step S1803, the evaluation line calculation unit 23 calculates an evaluation line serving as a base with respect to a line segment composed of the starting point and the first node.

In step S1804, the reference line setting unit 22 sets second and subsequent nodes by processing described below.

In step S1805, the evaluation line calculation unit 23 calculates an evaluation line by processing described below.

In step S1806, the color difference calculation unit 24 calculates a color difference between a reference point and an evaluation point (comparison point) on the evaluation line by processing similar to that described in step S304 in the first exemplary embodiment.

In step S1807, the color-difference map generation unit 25 generates a color-difference map by processing similar to that described in step S305 in the first exemplary embodiment, and the output unit 26 then displays the color-difference map on the monitor 105. After that, the information processing apparatus performs processing associated with ending.

### UI in Information Processing Application in Fourth Exemplary Embodiment

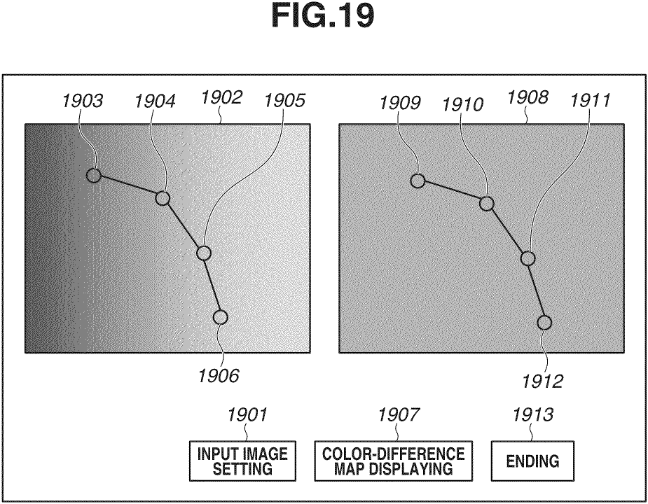

FIG. 19 is a schematic diagram representing a UI in the information processing apparatus in the fourth exemplary embodiment.

An input image setting button 1901 is a button via which the user issues an instruction in performing setting of an input image.

A color-difference map displaying button 1907 is a button via which the user issues an instruction in performing color-difference map displaying.

An ending button 1913 is a button via which the user issues an instruction in ending the application.

An image display window 1902 is a window in which to display an image set via the input image setting button 1901. A plotted point 1903 is a plotted point representing a starting point of the reference line and is designated by the user. A plotted point 1904 is a plotted point representing a first node of the reference line and is designated by the user. Furthermore, one or more plotted points representing nodes can be set, and a plotted point 1905 is a plotted point representing another node which is set differently from the plotted point 1904 representing the first node, and is is designated by the user. A plotted point 1906 is a plotted point representing an ending point of the reference line and is designated by the user. Furthermore, a node which is most recent when the color-difference map displaying button 1907 has been pressed can be set as an ending point of the reference line.

A color-difference map display window 1908 is a window in which to display the calculated color-difference map. A plotted point 1909 is a plotted point representing a starting point of the reference line, which indicates the same position as that of coordinates designated as the plotted point 1903 by the user. A plotted point 1910 and a plotted point 1911 are plotted points representing the respective nodes of the reference line, the plotted point 1910 indicates the same position as that of coordinates designated as the plotted point 1904 by the user, and the plotted point 1911 indicates the same position as that of coordinates designated as the plotted point 1905 by the user. A plotted point 1912 is a plotted point representing an ending point of the reference line, which indicates the same position as that of coordinates designated as the plotted point 1906 by the user.

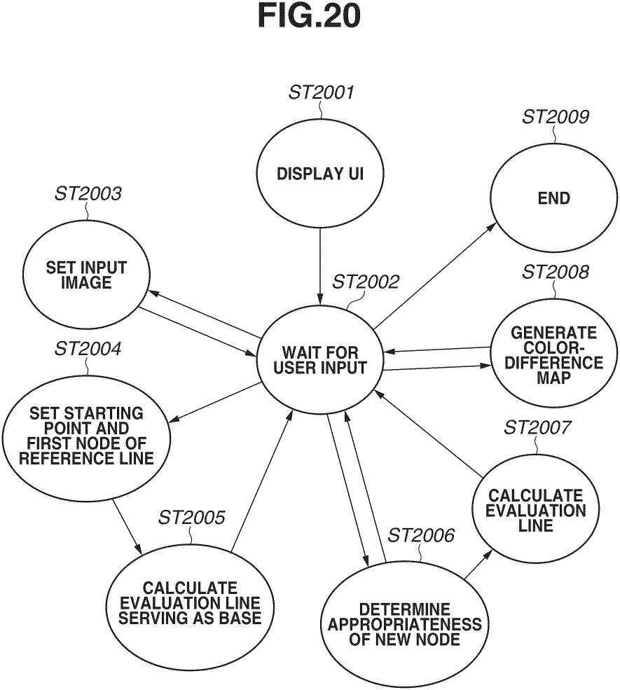

FIG. 20 is a state transition diagram illustrating a state transition in the information processing apparatus corresponding to user inputs to a UI according to the fourth exemplary embodiment.

When an application starting instruction is input from the user, the information processing apparatus transitions to a state ST2001, in which the information processing apparatus displays the UI on the monitor 105. After the state ST2001, the information processing apparatus transitions to a state ST2002.

In the state ST2002, when the input image setting button 1901 is pressed by the user, the information processing apparatus transitions to a state ST2003, in which the information processing apparatus reads an image designated by the user and displays the image in the image display window 1902. Image acquisition in the state ST2002 and the state ST2003 corresponds to image acquisition processing in step S1801, which is performed by the image acquisition unit 21. When the image acquisition processing in the state ST2003 is ended, the information processing apparatus transitions to the state ST2002.

Next, in the state ST2002, when the plotted point 1903 is set within the image display window 1902 by the user, the information processing apparatus transitions to a state ST2004. Then, in the state ST2004, when the plotted point 1904 is set as a first node, the information processing apparatus acquires coordinate information about an area which is set by the plotted point 1903 and the plotted point 1904. Acquisition of coordinate information in the state ST2004 corresponds to setting processing for the starting point and the first node of the reference line in step S1802, which is performed by the reference line setting unit 22.

Additionally, the information processing apparatus transitions to a state ST2005, in which the information processing apparatus calculates an evaluation line serving as a base with respect to the starting point and the first node of the reference line set in the state ST2004. The calculation of an evaluation line serving as a base in the state ST2005 corresponds to evaluation line calculation processing in step S1803, which is performed by the evaluation line calculation unit 23. After the state ST2005, the information processing apparatus transitions to the state ST2002.

Here, as mentioned above, a plurality of nodes can be set on the reference line, and, if a plotted point is set as a new node in the state ST2002, the information processing apparatus transitions to a state ST2006. In the state ST2006, the information processing apparatus performs appropriateness determination as to whether the newly added node is appropriate for evaluation line setting. Then, if it is determined that the new node is an appropriate node, the information processing apparatus adds such a node and then transitions to a state ST2007, and, on the other hand, if it is determined that the new node is not an appropriate node, the information processing apparatus does not add such a node and then transitions to the state ST2002. Moreover, each time a new node is further added in the state ST2002, the information processing apparatus repeats processing for new node addition and determination in the state ST2006 in a manner similar to the above processing. Furthermore, new node addition and determination in the state ST2006 correspond to step S 1804, which is performed by the reference line setting unit 22.

Upon transitioning to the state ST2007, the information processing apparatus performs calculation of an evaluation line and calculation of an evaluation point (comparison point) on the evaluation line. This processing in the state ST2007 corresponds to evaluation line calculation processing in step S1805, which is performed by the evaluation line calculation unit 23. After processing in the state ST2007, the evaluation line calculation unit 23 transitions to the state ST2002.

Next, in the state ST2002, when the color-difference map displaying button 1907 is pressed, the information processing apparatus transitions to a state ST2008. Upon transitioning to the state ST2008, the information processing apparatus calculates color differences and performs generation of a color-difference map and displaying of the color-difference map in the color-difference map display window 1908. Color difference calculation in the state ST2008 corresponds to color difference calculation processing in step S 1806, which is performed by the color difference calculation unit 24, and generation of a color-difference map in the state ST2008 corresponds to color-difference map generation processing in step S1807, which is performed by the color-difference map generation unit 25. After the state ST2008, the information processing apparatus transitions to the state ST2002.

After that, in the state ST2002, when the ending button 1913 is pressed by the user instruction, the information processing apparatus transitions to a state ST2009, in which the information processing apparatus performs processing associated with ending.

### Processing Flow for Node Addition in Step S1804

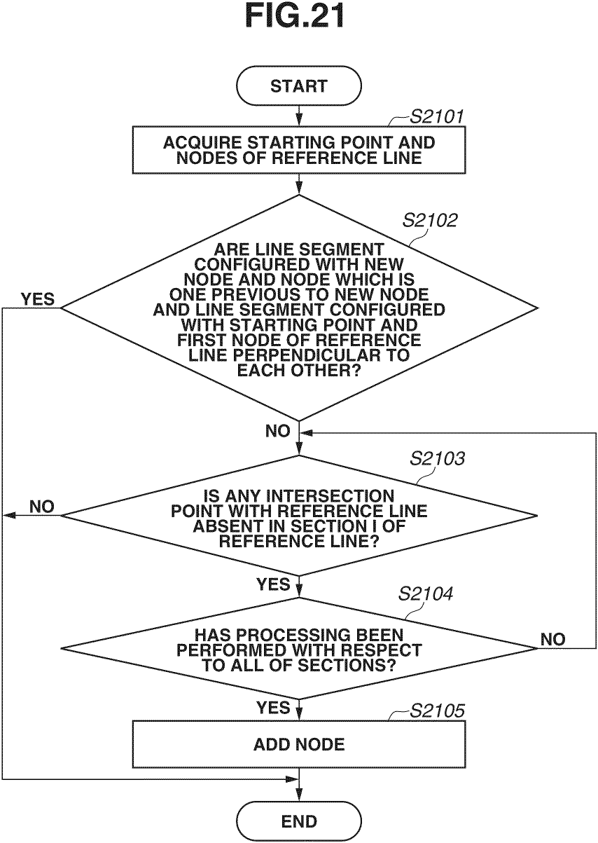

FIG. 21 is a flowchart illustrating the flow of processing for node addition, which is performed by the evaluation line calculation unit 23 of the information processing apparatus in the fourth exemplary embodiment.

First, in step S2101, the evaluation line calculation unit 23 acquires a starting point and nodes of the reference line.

Next, in step S2102, the evaluation line calculation unit 23 determines whether a line segment which connects a new node and a node which is one previous to the new node and a line segment which connects the starting point and the first node of the reference line satisfy a condition defined by formula (21). If it is determined that such line segments satisfy the condition defined by formula (21) (NO in step S2102), the evaluation line calculation unit 23 advances the processing to step S2103, and, if not so (YES in step S2102), the evaluation line calculation unit 23 performs processing associated with ending. Furthermore, the coordinates of the starting point are assumed to be (xₛ, yₛ), the coordinates of the first node are assumed to be (x₁, y₁), the coordinates of the new node are assumed to be (xₙ, yₙ), and the coordinates of the node which is one previous to the new node are assumed to be (xₙ₋₁, yₙ₋₁).

$$\frac{\left({y}_{1} - {y}_{s}\right) \times \left({y}_{n} - {y}_{n - 1}\right)}{\left({x}_{1} - {x}_{s}\right) \times \left({x}_{n} - {x}_{n - 1}\right)} \neq - 1$$

Moreover, a straight line perpendicular to a line segment which connects the i-th node and the (i-1)th node, which is a node which is adjacent to and one previous to the i-th node, and passing thorough the i-th node is expressed by formula (22). Moreover, a straight line perpendicular to a line segment which connects the i-th node and the (i-1)th node, which is a node which is adjacent to and one previous to the i-th node, and passing thorough the (i-1)th node is expressed by formula (23). In step S2103, the evaluation line calculation unit 23 calculates respective intersection points between the above-mentioned two straight lines related to the n-th, newly added, node and between the above-mentioned two straight lines related to another node, and determines whether, for example, any intersection point is absent within a predetermined region in the image. Here, this processing in step S2103 corresponds to the above-mentioned appropriateness determination in the state ST2006. Then, if, in step S2103, it is determined that any intersection point is absent within the predetermined region (YES in step S2103), the evaluation line calculation unit 23 advances the processing to step S2104, and, if not so (NO in step S2103), the evaluation line calculation unit 23 performs processing associated with ending. Thus, during evaluation line calculation, the evaluation line calculation unit 23 causes an evaluation line (second line segment) in a section connecting two adjacent nodes and an evaluation line (second line segment) in a section connecting two other adjacent nodes not to intersect with each other within the predetermined region.

$$\text{y} = - \frac{{x}_{i} - {x}_{i - 1}}{{y}_{i} - {y}_{i - 1}} \left(x - {x}_{i}\right) + {y}_{i}$$

$$\text{y} = - \frac{{x}_{i} - {x}_{i - 1}}{{y}_{i} - {y}_{i - 1}} \left(x - {x}_{i - 1}\right) + {y}_{i - 1}$$

In step S2104, the evaluation line calculation unit 23 determines whether processing has been performed with respect to all of the sections, and, if it is determined that processing on all of the sections has not yet been completed (NO in step S2104), the evaluation line calculation unit 23 returns the processing to step S2103 and, it is determined that processing on all of the sections has been completed (YES in step S2104), the evaluation line calculation unit 23 advances the processing to step S2105.

In step S2105, the evaluation line calculation unit 23 determines that a node designated as a new node is a new node which has been determined to be appropriate in appropriateness determination, and records the determined node. After that, the evaluation line calculation unit 23 performs processing associated with ending.

### Evaluation Line Calculation Processing Flow in Step S1805

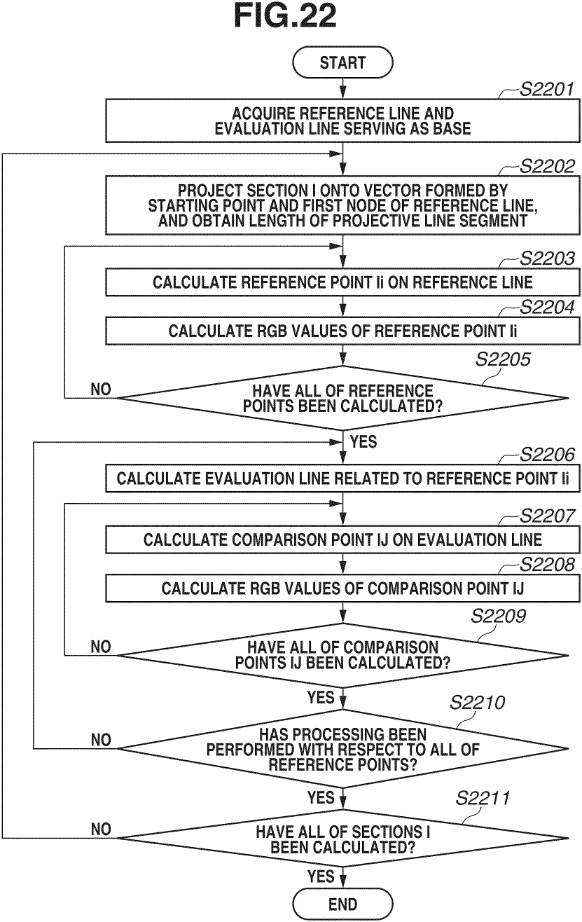

FIG. 22 is a flowchart illustrating the flow of evaluation line calculation processing which is performed by the evaluation line calculation unit 23 of the information processing apparatus according to the fourth exemplary embodiment.

First, in step S2201, the evaluation line calculation unit 23 acquires a reference line and an evaluation line serving as a base.

Next, in step S2202, the evaluation line calculation unit 23 projects a section I onto a vector formed by a starting point and a first node of the reference line, and obtains the length of the projective line segment. Here, a node section which is used to perform projection is denoted by “I”, and the initial value thereof is assumed to be “1”. Moreover, a straight line passing through a node which is one previous to a new node and being parallel to a vector formed by the starting point and the first node of the reference line is expressed by formula (24).

$$\text{y} = \frac{y 1 - y s}{x 1 - x s} \left(x - {x}_{n - 1}\right) + {y}_{n - 1}$$

Moreover, when projection destination coordinates of the new node are assumed to be (x′ₙ, y′ₙ), the projection destination coordinates become as expressed by formulae (25).

$$\begin{matrix}{{x}^{′}}_{n} = \frac{\left(x 1 - x s\right) \times \left(y 1 - y s\right)}{{\left(x 1 - x s\right)}^{2} + {\left(y 1 - y s\right)}^{2}} \\ \times \left(\frac{y 1 - y s}{x 1 - x s} \times {x}_{n - 1} + \frac{x 1 - s s}{y 1 - y s} \times {x}_{n} - {y}_{n - 1} + {y}_{n}\right) \\ {{y}^{′}}_{n} = \frac{y 1 - y s}{x 1 - x s} \\ \times \left(\frac{\left(x 1 - x s\right) \times \left(y 1 - y s\right)}{{\left(x 1 - x s\right)}^{2} + {\left(y 1 - y s\right)}^{2}}\right) \\ \left(\times \left(\frac{y 1 - y s}{x 1 - x s} \times {x}_{n - 1} + \frac{x 1 - x s}{y 1 - y s} \times {x}_{n} - {y}_{n - 1} + {y}_{n}\right) - {x}_{n - 1}\right) \\ + {y}_{n - 1}\end{matrix}$$

Additionally, the evaluation line calculation unit 23 calculates the number of reference points in the section I by formula (26).

$$\text{N} = \left⌊\sqrt{{\left({{x}^{′}}_{n} - {x}_{n - 1}\right)}^{2} + {\left({{y}^{′}}_{n} - {y}_{n - 1}\right)}^{2}}\right⌋$$

Next, in step S2203, the evaluation line calculation unit 23 calculates coordinates of a reference point by formulae (27). Here, coordinates of the i-th reference point in the section I is expressed by (xi, yi).

$$\begin{matrix}\text{xi} = {x}_{n - 1} + \frac{i}{N} \left({x}_{n} - {x}_{n - 1}\right) \\ \text{yi} = {y}_{n - 1} + \frac{i}{N} \left({y}_{n} - {y}_{n - 1}\right)\end{matrix}$$

Next, in step S2204, the evaluation line calculation unit 23 calculates RGB values of the reference point Ii by the above-mentioned formulae (3).

Next, in step S2205, the evaluation line calculation unit 23 determines whether processing has been performed with respect to all of the reference points in the section I, and, if it is determined that processing has not been performed with respect all of the reference points (NO in step S2205), the evaluation line calculation unit 23 returns the processing to step S2203 and, if it is determined that processing has been performed with respect all of the reference points (YES in step S2205), the evaluation line calculation unit 23 advances the processing to step S2206.

In step S2206, the evaluation line calculation unit 23 calculates the I-th evaluation line related to the reference point Ii by formula (28).

$$\text{y} = - \frac{{x}_{n} - {x}_{n - 1}}{{y}_{n} - {y}_{n - 1}} \left(x - x i\right) + y i$$

Next, in step S2207, the evaluation line calculation unit 23 calculates a comparison point IJ on the evaluation line. The comparison point is calculated by use of the above-mentioned formula (5) and formulae (6).

Next, in step S2208, the evaluation line calculation unit 23 calculates RGB values of the comparison point IJ. The RGB values (Rij, Gij, Bij) of the comparison point IJ are calculated by use of the above-mentioned formulae (7).

Next, in step S2209, the evaluation line calculation unit 23 determines whether processing has been performed with respect all of the comparison points IJ, and, if it is determined that processing has been performed (YES in step S2209), the evaluation line calculation unit 23 adds “1” to “I” and then advances the processing to step S2210 and, if not so (NO in step S2209), the evaluation line calculation unit 23 adds “1” to “J” and then returns the processing to step S2207.

In step S2210, the evaluation line calculation unit 23 determines whether evaluation lines have been calculated with respect to all of the reference points, and, if it is determined that evaluation lines have been calculated with respect to all of the reference points (YES in step S2210), the evaluation line calculation unit 23 advances the processing to step S2211 and, if not so (NO in step S2210), the evaluation line calculation unit 23 returns the processing to step S2206.

In step S2211, the evaluation line calculation unit 23 determines whether processing has been performed with respect to all of the sections, and, if it is determined that processing has not been performed with respect to all of the sections (NO in step S2211), the evaluation line calculation unit 23 returns the processing to step S2202 and, if it is determined that processing has been performed with respect to all of the sections (YES in step S2211), the evaluation line calculation unit 23 performs processing associated with ending.

As described above, the information processing apparatus in the fourth exemplary embodiment sets a reference line with use of a plurality of nodes, thus being able to obtain a reference line which is distributed in a curved manner. Thus, according to the fourth exemplary embodiment, it is possible to generate a color-difference map even in a case where the aggregate of reference points has a distribution which is not in a linear fashion.

In the above-described exemplary embodiments, an example in which a reference line is set based on the designation performed by the user and, additionally, an evaluation line is also set or calculated has been described. However, at the scene of execution of a color inspection, the evaluation of color differences corresponding to distances from a boundary between different components may be requested. Therefore, in a fifth exemplary embodiment, an example of extracting, from image data obtained by capturing an image of, for example, various components as subjects, a borderline (hereinafter referred to as a “boundary line”) between such components and then calculating a reference line and an evaluation line based on the extracted boundary line is described. Furthermore, the hardware configuration of an information processing apparatus in the fifth exemplary embodiment is similar to that in the first exemplary embodiment and is, therefore, omitted from illustration and description. In the following fifth exemplary embodiment, features different from those in the first exemplary embodiment are mainly described.

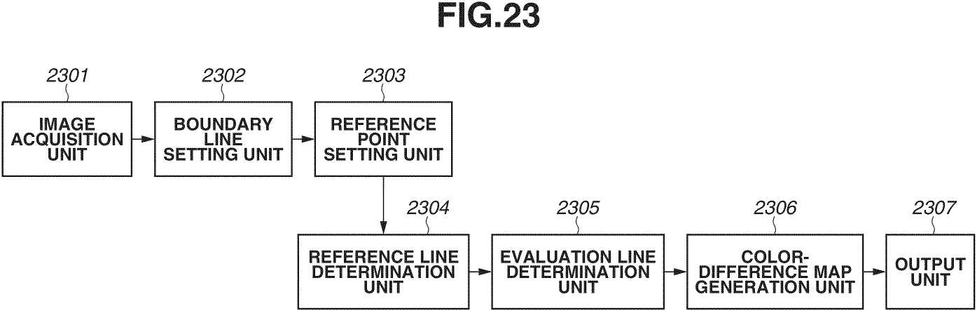

FIG. 23 is a block diagram illustrating a logical configuration of the information processing apparatus according to the fifth exemplary embodiment. The information processing apparatus in the fifth exemplary embodiment includes an image acquisition unit 2301, a boundary line setting unit 2302, a reference point setting unit 2303, a reference line determination unit 2304, an evaluation line determination unit 2305, a color-difference map generation unit 2306, and an output unit 2307.

The image acquisition unit 2301 acquires captured image data which has been input according to an instruction from the user.

The boundary line setting unit 2302 performs boundary setting processing for, with respect to captured image data acquired by the image acquisition unit 2301, setting a boundary line for performing region segmentation of an image represented by the captured image data. In the case of the present exemplary embodiment, the boundary line setting unit 2302 detects a boundary portion between subjects such as components shown in the captured image, and generates binary image data obtained by performing region segmentation in such a manner that the detected boundary portion is set to “1” and the other region is set to “0”. Thus, in the present exemplary embodiment, a boundary line for performing region segmentation of an image is a line of the boundary portion between “1” and “0” of the binary image data. Examples of such processing include processing which is performed by extracting the color of a line of the boundary portion between components by known threshold value processing. Furthermore, the present exemplary embodiment is not limited to this method, and processing for extracting an edge of the boundary portion by, for example, by the Canny’s method can be employed.

The reference point setting unit 2303 sets one point through which the reference line passes within an image acquired by the image acquisition unit 2301, based on a designation performed by the user. Furthermore, in the present exemplary embodiment, one point through which the reference line passes is assumed to be a reference point designated by the user, but is not limited to the reference point and can be of any form as long as it is information for enabling knowing a distance between the boundary line and the reference line and on which side of the boundary line to place the reference line.

The reference line determination unit 2304 determines a reference line based on the boundary line and the reference point. The details of this processing are described below.

The evaluation line determination unit 2305 determines an evaluation line based on the reference line. The details of this processing are described below.

The color-difference map generation unit 2306 generates a color-difference map based on the reference line and the evaluation line.

The details of this processing are described below.

The output unit 2307 displays the generated color-difference map on the monitor 105.

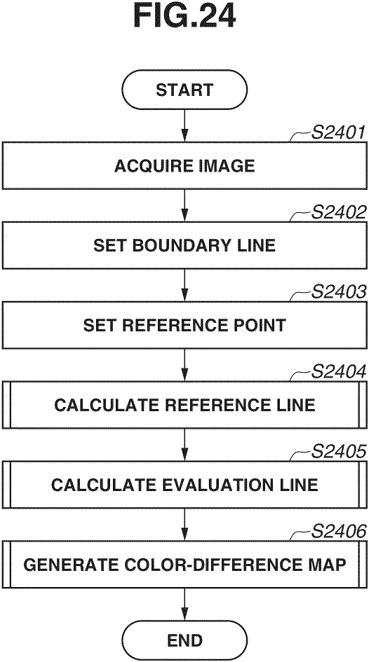

FIG. 24 is a flowchart illustrating the flow of the entirety of information processing which is performed by the information processing apparatus in the fifth exemplary embodiment. Furthermore, an operation to be described below is started by the user starting an information processing application and, then, the user inputting a predetermined instruction to a user interface (UI) described below.

In step S2401, the image acquisition unit 2301 acquires captured image data.

In step S2402, the boundary line setting unit 2302 sets a boundary line based on a boundary between, for example, components in the captured image.

In step S2403, the reference point setting unit 2303 sets a reference point. In the case of the present exemplary embodiment, the reference point is assumed to be designated by the user.

In step S2404, the reference line determination unit 2304 calculates a reference line based on the boundary line and the reference point.

In step S2405, the evaluation line determination unit 2305 calculates an evaluation line based on the reference line.

In step S2406, the color-difference map generation unit 2306 generates a color-difference map, and the output unit 2307 displays the color-difference map on the monitor 105.

### UI in Information Processing Application in Fifth Exemplary Embodiment

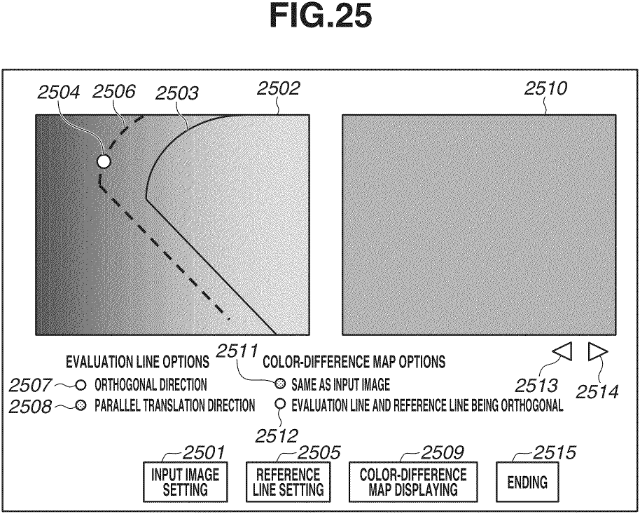

FIG. 25 is a schematic diagram representing a UI in the information processing apparatus in the fifth exemplary embodiment.

An input image setting button 2501 is a button via which the user issues an instruction in performing setting of an input image.

A reference line setting button 2505 is a button which the user presses in causing the reference line determination unit 2304 to perform processing. In response to the reference line setting button 2505 being pressed, as described below, the reference line determination unit 2304 calculates a reference line 2506 based on a reference point 2504.

A color-difference map displaying button 2509 is a button which the user presses in causing the color-difference map generation unit 2306 to perform processing. In response to the color-difference map displaying button 2509 being pressed, the color-difference map generation unit 2306 generates a color-difference map.

Options 2507 and 2508 are buttons via which the user issues an instruction in selecting respective options concerning reference line and evaluation line calculation. The option 2507 represents an orthogonal direction option described below and the option 2508 represents a parallel translation direction option described below, any one of which the user selects. The shape of the reference line 2506 becomes different depending on a result of selection of the orthogonal direction option 2507 or the parallel translation direction option 2508.

Display switching buttons 2513 and 2514 are buttons via which, in a case where the boundary line is divided into a plurality of divisional boundary lines as described below, the user issues an instruction for performing switching for displaying a color-difference map for each divisional boundary line.

An ending button 2515 is a button via which the user presses in ending the application.

An image display window 2502 is a window in which to display an image which has been set by the input image setting button 2501. In response to an input image being set, a line representing a boundary line 2503 is displayed in the image display window 2502. Moreover, a reference point 2504 corresponding to the designation performed by the user is displayed in the image display window 2502. Moreover, in a case where the reference line setting button 2505 has been pressed, a reference line 2506 which has been calculated by the reference line determination unit 2304 in a way described below is displayed in the image display window 2502.

A color-difference map display window 2510 is a window in which to display the calculated color-difference map. In a case where the color-difference map displaying button 2509 has been pressed, the output unit 2307 displays, in the color-difference map display window 2510, a color-difference map generated by the color-difference map generation unit 2306. Moreover, for example, in a case where the display switching button 2514 has been pressed, a color-difference map calculated in association with different boundary lines obtained by division in a way described below is displayed in the color-difference map display window 2510. On the other hand, in a case where the display switching button 2513 has been pressed, a color-difference map which has been displayed before the display switching button 2514 is pressed is displayed in the color-difference map display window 2510.

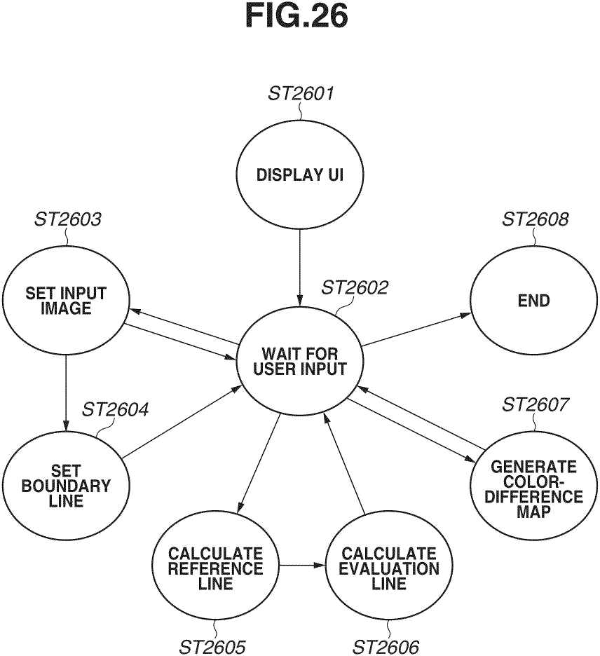

FIG. 26 illustrates a state transition in the information processing apparatus corresponding to user inputs to the UI according to the fifth exemplary embodiment.

When an application starting instruction is input from the user, the information processing apparatus transitions to a state ST2601, in which the information processing apparatus displays a UI on the monitor 105. After the state ST2601, the information processing apparatus transitions to a state ST2602.

In the state ST2602, when the input image setting button 2501 is pressed by the user, the information processing apparatus transitions to a state ST2603, in which the information processing apparatus reads an image designated by the user and displays the image in the image display window 2502. Image acquisition in the state ST2602 and the state ST2603 corresponds to image acquisition processing in step S2401, which is performed by the image acquisition unit 2301. When the image acquisition processing in the state ST2603 is ended, the information processing apparatus transitions to a state ST2604.

In the state ST2604, the information processing apparatus sets the boundary line 2503 based on the input captured image, and displays the boundary line 2503 as well as the captured image in the image display window 2502. Boundary line setting in the state ST2604 corresponds to boundary line setting processing in step S2402, which is performed by the boundary line setting unit 2302. After the state ST2604, the information processing apparatus transitions to the state ST2602.

Next, in the state ST2602, when, in a state in which the boundary line 2503 is displayed, a reference point is designated by the user and the reference line setting button 2505 is pressed by the user, the information processing apparatus transitions to a state ST2605. In the state ST2605, the information processing apparatus sets the reference point 2504 in the image display window 2502, calculates a reference line based on the reference point 2504 and the boundary line 2503, and displays the reference line 2506 in the image display window 2502. Reference point setting corresponds to reference point setting processing in step S2403, which is performed by the reference point setting unit 2303, and reference line calculation corresponds to reference line calculation processing in step S2404, which is performed by the reference line determination unit 2304. After the state ST2605, the information processing apparatus transitions to a state ST2606.

Upon transitioning to the state ST2606, the information processing apparatus calculates an evaluation line based on the reference line. Calculation of an evaluation line in the state ST2606 corresponds to evaluation line calculation processing in step S2405, which is performed by the evaluation line determination unit 2305. Then, after the state ST2606, the information processing apparatus transitions to the state ST2602.

Next, in the state ST2602, when the color-difference map displaying button 2509 is pressed by the user, the information processing apparatus transitions to a state ST2607. In the state ST2607, the information processing apparatus performs calculation of color differences, generation of color-difference map, and displaying of the color-difference map by processing similar to that in the above-described exemplary embodiments. Color difference calculation and color-difference map generation in the state ST2607 correspond to processing in step S2406, which is performed by the color-difference map generation unit 2306. Then, the generated color-difference map is displayed in the color-difference map display window 2510 by the output unit 2307. After the state ST2607, the information processing apparatus transitions to the state ST2602.

After that, in the state ST2602, when the ending button 2515 is pressed by the user, the information processing apparatus transitions to a state ST2608, in which the information processing apparatus performs processing associated with ending.

### Reference Line Calculation Processing Flow in Step S2404

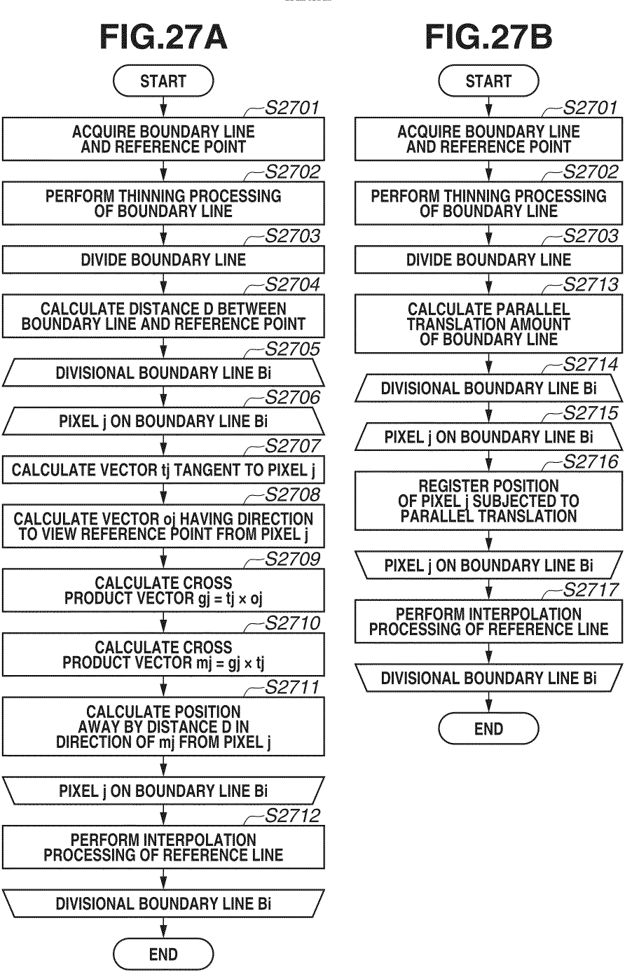

FIGS. 27A and 27B are flowcharts illustrating the details of reference line calculation processing which the reference line determination unit 2304 in the fifth exemplary embodiment performs in step S2404.

Here, reference line calculation processing which the reference line determination unit 2304 performs in step S2404 becomes different between a case where the orthogonal direction option 2507 is selected and a case where the parallel translation direction option 2508 is selected.

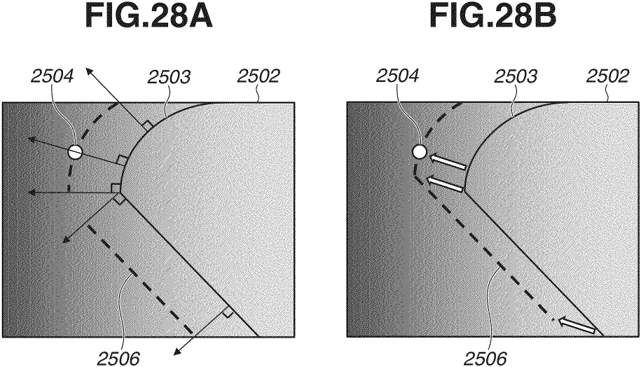

FIGS. 28A and 28B are diagrams used to explain a difference in the reference line calculated depending on such a difference in option, each of which illustrates the image display window 2502.

In a case where the orthogonal direction option 2507 has been selected, in step S2404, the reference line determination unit 2304 calculates the reference line 2506 such as that indicated by a dashed line in FIG. 28A. Thus, in a case where the orthogonal direction option 2507 has been selected, the reference line determination unit 2304 generates, as the reference line 2506, an aggregate of points which are perpendicular to and away at equal distance from the respective points on the boundary line 2503. Moreover, although details are described below, the evaluation line determination unit 2305 in a case where the orthogonal direction option 2507 has been selected determines an evaluation line perpendicular to the reference line, in other words, an evaluation line perpendicular to the boundary line.

On the other hand, in a case where the parallel translation direction option 2508 has been selected, in step S2404, the reference line determination unit 2304 calculates the reference line 2506 such as that indicated by a dashed line in FIG. 28B. Thus, in a case where the parallel translation direction option 2508 has been selected, the reference line determination unit 2304 generates, as the reference line 2506, an aggregate of points obtained by performing parallel translation of the respective points on the boundary line 2503. Moreover, although details are described below, the evaluation line determination unit 2305 in a case where the parallel translation direction option 2508 has been selected determines an evaluation line parallel to the parallel translation, in other words, an evaluation line parallel to the boundary line.

FIG. 27A is a flowchart for a case where the orthogonal direction option 2507 is selected, and FIG. 27B is a flowchart for a case where the parallel translation direction option 2508 is selected.

The description starts with the flowchart of FIG. 27A.

First, in step S2701, the reference line determination unit 2304 acquires a boundary line and a reference point. Here, binary image data representing a boundary line set in step S2402 and coordinate information about a reference point set in step S2403 are assumed to be currently retained in, for example, the main memory 102 or the HDD 103. Accordingly, the reference line determination unit 2304 acquires binary image data representing a boundary line and coordinate information about a reference point from the main memory 102 or the HDD 103.

Next, in step S2702, the reference line determination unit 2304 performs thinning processing of the boundary line. Thus, for example, the reference line determination unit 2304 performs thinning processing on binary image data representing the boundary line in such a manner that the boundary line becomes a line having a width of one pixel and using 4-neighbor connection or 8-neighbor connection. This processing can be performed by various known methods, such as a method of repeatedly performing processing for substituting a pixel the pixel value of which becomes non-zero in binary image data representing the boundary line with a pixel value “0” according to a pattern of pixels adjacent to the pixel.

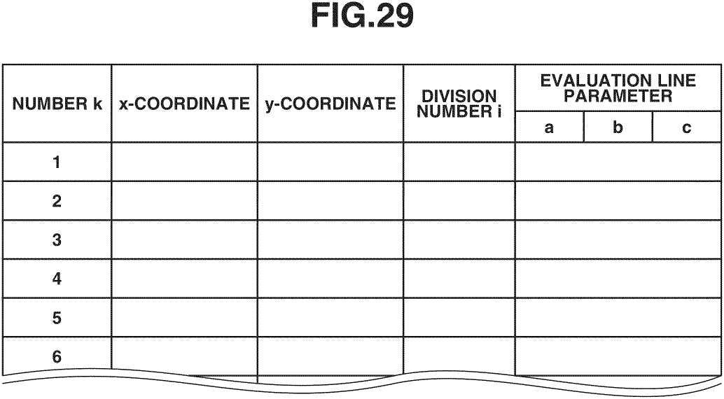

Additionally, in step S2702, the reference line determination unit 2304 performs extraction of a boundary line from the binary image data. For example, the reference line determination unit 2304 searches for an end of a boundary line having pixel values of non-zero in binary image data subjected to thinning processing, and records coordinates of the found end on the first row of a list illustrated in FIG. 29. Next, the reference line determination unit 2304 searches for a pixel connected to a pixel of the end of the boundary line, and records coordinates of the found pixel on the second row of the list. The reference line determination unit 2304 repeats such processing until the processing reaches an opposite end of the boundary line. Furthermore, while columns for division number and evaluation line parameters illustrated in FIG. 29 are described below, here, none are recorded on these columns.

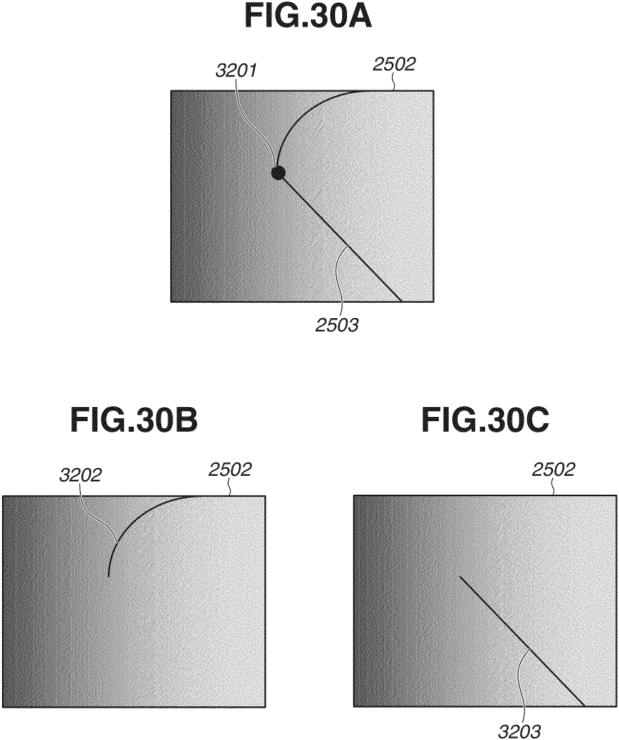

Next, in step S2703, the reference line determination unit 2304 performs processing for detecting, for example, a changing point at which the curvature of the boundary line rapidly changes or a changing point at which the boundary line changes from a straight line to a curved line (hereinafter referred to as a “discontinuity point”) and then dividing the boundary line at the detected discontinuity point. FIGS. 30A, 30B, and 30C are diagrams used to explain such processing, each of which illustrates the image display window 2502. The reference line determination unit 2304 extracts a point at which the boundary line 2503 becomes discontinuous, such as a point 3201 illustrated in FIG. 30A. In this processing, for example, a point (k) at which the Cₖ value in formula (29), which is a quadratic differential of the boundary line becomes larger than a threshold value is assumed to be a discontinuity point. In this respect, the point (k) indicates a number in the list illustrated in FIG. 29, and (xₖ, yₖ) indicates x- and y-coordinates recorded on the same row as that for each number.

$${\text{C}}_{\text{k}} = {\left({\text{x}}_{\text{k+1}} {\text{- 2x}}_{\text{k}} + {\text{x}}_{\text{k-1}}\right)}^{2} + {\left({\text{y}}_{\text{k+1}} {\text{- 2y}}_{\text{k}} + {\text{y}}_{\text{k-1}}\right)}^{2}$$

Furthermore, extraction processing of a discontinuity point is not limited to this, and, for example, the reference line determination unit 2304 can extract a Harris corner with respect to captured image data and detect the extracted pixel as a discontinuity point.

Next, the reference line determination unit 2304 divides the boundary line 2503 with the discontinuity point 3201 set as a point of division into divisional lines such as a divisional line 3202 illustrated in FIG. 30B and a divisional line 3203 illustrated in FIG. 30C. Specifically, the reference line determination unit 2304 performs processing for assigning different numbers with the number “k” serving as a discontinuity point set as a border to the column for division number in the list illustrated in FIG. 29.

The description refers back to FIG. 27A. In step S2704, the reference line determination unit 2304 calculates a difference D between the reference point and the boundary line. Here, for example, the reference line determination unit 2304 performs processing for calculating a Euclidean distance between the coordinate values in each row of the list illustrated in FIG. 29 and the coordinate values of the reference point and sets their minimum value as the distance D.

Next, in loop processing starting with step S2705, the reference line determination unit 2304 sets a division number in the list illustrated in FIG. 29 as Bᵢ and performs processing in step S2706 to step S2712 with respect to all of the division numbers while changing Bi.

Moreover, in loop processing starting with step S2706, the reference line determination unit 2304 performs processing in step S2707 to step S2711 with respect to all of the pixels on the divisional boundary line, in other words, all of the rows having the same division number Bi in the list illustrated in FIG. 29.

In step S2707, the reference line determination unit 2304 calculates a vector tⱼ tangent to a pixel on the j-th row. This processing can be expressed by formula (30).

$$\vec{{t}_{J}} = {\left[{x}_{j + 1} - {x}_{j - 1} , {y}_{j + 1} - {y}_{j - 1} , 0\right]}^{t} / \sqrt{{\left({x}_{j + 1} - {x}_{j - 1}\right)}^{2} + {\left({y}_{j + 1} - {y}_{j - 1}\right)}^{2}}$$

Next, in step S2708, the reference line determination unit 2304 calculates a vector oⱼ having a direction to view the reference point from a pixel on the j-th row, by formula (31). In this respect, (xₒ, yₒ) indicates x- and y-coordinates of the reference point.

$$\vec{{o}_{J}} = {\left[{x}_{j} - {x}_{o} , {y}_{j} - {y}_{o} , 0\right]}^{t} / \sqrt{{\left({x}_{j} - {x}_{o}\right)}^{2} + {\left({y}_{j} - {y}_{o}\right)}^{2}}$$

Next, in step S2709, the reference line determination unit 2304 calculates the cross product vector gⱼ of the cross products tⱼ and oⱼ by formula (32).

$$\vec{{g}_{J}} = \left(\vec{{t}_{J}} \times \vec{{o}_{J}}\right) / \left|\vec{{t}_{J}} \times \vec{{o}_{J}}\right|$$

The cross product vector gⱼ calculated by formula (32) becomes [0, 0, 1] or [0, 0, -1], so that this enables discriminating on which of the right and left sides the reference point is present with respect to the boundary line.

Next, in step S2710, the reference line determination unit 2304 calculates the cross product vector mⱼ of the cross products gⱼ and tⱼ by formula (33). This is processing for calculating a direction perpendicular to the vector tⱼ in the xy-plane.

$$\vec{{m}_{J}} = \left(\vec{{g}_{J}} \times \vec{{t}_{J}}\right) / \left|\vec{{g}_{J}} \times \vec{{t}_{J}}\right|$$

Next, in step S2711, the reference line determination unit 2304 calculates a position away by the distance D in a direction perpendicular to the vector tⱼ, by formula (34).

$$\vec{{p}_{J}} = D ⋅ \vec{{m}_{J}} + {\left[{x}_{j} , {y}_{j} , 0\right]}^{t}$$

Moreover, in step S2711, the reference line determination unit 2304 adds a new row to a list showing reference lines in the form illustrated in FIG. 29 (a list different from the list showing boundary lines), and records x- and y-coordinates of the position pⱼ and the value of the division number Bⱼ obtained at that time on an associated column.

The reference line determination unit 2304 performs the above-described processing in step S2707 to step S2711 with respect to all of the pixels on the divisional boundary line, thus generating a list of the corresponding reference lines. However, in the list of reference lines, a line may not necessary be continuous. In this case, in step S2712, the reference line determination unit 2304 performs interpolation processing using a known method, such as linear interpolation or spline interpolation, in such a way as to make the line continuous.

Specifically, in a case where the Euclidean distance between coordinate values of adjacent rows is larger than “1” in the list of reference lines, the reference line determination unit 2304 inserts a new row and records coordinate values obtained by interpolation processing on the new row. The reference line determination unit 2304 repeatedly performs this processing until any coordinate values the Euclidean distance of which is larger than “1” disappear.

By performing the above-described processing in the flowchart of FIG. 27A, the reference line determination unit 2304 is able to generate a reference line away by a predetermined distance in a direction perpendicular to the boundary line.

FIG. 27B is a flowchart for a case where the parallel translation direction option 2508 is selected, and processing in step S2701 to step S2703 is the same as that illustrated in FIG. 27A and is, therefore, omitted from description.

In step S2713, the reference line determination unit 2304 calculates a parallel translation amount based on the reference line and the reference point. Here, first, the reference line determination unit 2304 calculates a Euclidean distance between the coordinate values in each row of the list of boundary lines and the coordinate values of the reference point, and records coordinate values on the row the Euclidean distance of which becomes minimum. Then, the reference line determination unit 2304 calculates a parallel translation amount vector “s” based on the obtained coordinate values by formula (35). Furthermore, (xₒ, yₒ) indicates x- and y-coordinate values of the reference point, and (x_{d}, y_{d}) indicates coordinate values on the row the Euclidean distance of which becomes minimum.

$$\vec{s} = {\left[{x}_{o} - {x}_{d} , {y}_{o} - {y}_{d}\right]}^{t}$$

Next, in loop processing starting with step S2714, the reference line determination unit 2304 sets a division number in the list of boundary lines illustrated in FIG. 29 as Bi and performs subsequent processing in step S2715 to step S2717 with respect to all of the division numbers while changing Bi.

Moreover, in loop processing starting with step S2715, the reference line determination unit 2304 performs processing in step S2716 with respect to all of the pixels on the divisional boundary line, in other words, all of the rows having the same division number Bi in the list of boundary lines.

Then, in step S2716, the reference line determination unit 2304 calculates coordinate values pⱼ of a pixel subjected to parallel translation with respect to a pixel on the j-th row. This processing is able to be performed by use of formula (36).

$${\vec{p}}_{j} = {\vec{s}}_{j} + {\left[{x}_{j} , {y}_{j}\right]}^{t}$$

Moreover, in step S2716, the reference line determination unit 2304 adds a new row to a list showing reference lines in the form illustrated in FIG. 29, and records x- and y-coordinates of the position pⱼ and the value of the division number Bⱼ obtained at that time on an associated column.

Next, in step S2717, the reference line determination unit 2304 performs interpolation processing in such a way as to make a line continuous in the list of reference lines calculated in the above-mentioned manner. This processing is the same processing as that in step S2712 and is, therefore, omitted from description.

By performing the above-described processing in the flowchart of FIG. 27B, the reference line determination unit 2304 is able to generate a reference line obtained by performing parallel translation of the boundary line.

### Evaluation Line Calculation Processing Flow in Step S2405

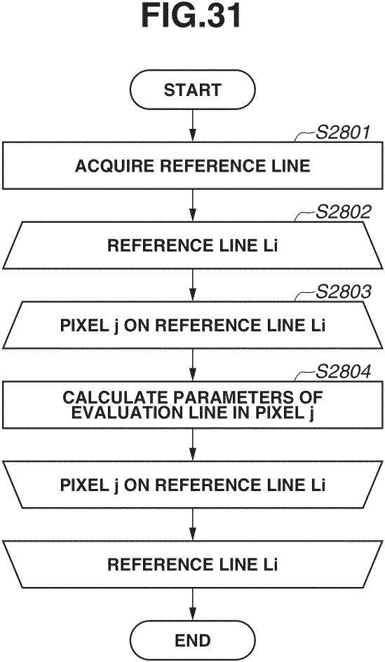

FIG. 31 is a flowchart illustrating the flow of evaluation line calculation processing which the evaluation line calculation unit 2305 performs in step S2405.

First, in step S2801, the evaluation line determination unit 2305 reads a list of reference lines calculated in step S2404. As mentioned above, this list is assumed to be currently retained in, for example, the main memory 102 or the HDD 103 in the form illustrated in FIG. 29.

Next, in loop processing starting with step S2802, the evaluation line determination unit 2305 sets a division number in the list of reference lines as Li and performs subsequent processing in step S2803 to step S2804 with respect to all of the division numbers while changing Li.

Moreover, in loop processing starting with step S2803, the evaluation line determination unit 2305 performs processing in step S2804 with respect to all of the pixels on the divisional reference line, in other words, all of the rows having the same division number Li.

In step S2804, the evaluation line determination unit 2305 calculates parameters for the evaluation line with respect to a pixel on the j-th row. Here, the parameters for the evaluation line indicates, for example, parameters aⱼ, bⱼ, and cⱼ in an equation for a straight line expressed by formula (37).

$${\text{a}}_{\text{j}} \text{x} + {\text{b}}_{\text{j}} \text{y} + {\text{c}}_{\text{j}} = 0$$

Here, in a case where the orthogonal direction option 2507 is selected, these parameters are calculated by formula (38) in such a way as to become perpendicular to the tangent vector.

$${\text{a}}_{\text{j}} = {\text{x}}_{\text{j} + 1} {\text{- x}}_{\text{j-1}}$$

$${\text{b}}_{\text{j}} = {\text{y}}_{\text{j} + 1} {\text{- y}}_{\text{j-1}}$$

$${\text{c}}_{\text{j}} = \text{-a} ⋅ {\text{x}}_{\text{j}} \text{- b} ⋅ {\text{y}}_{\text{j}}$$

On the other hand, in a case where the parallel translation direction option 2508 is selected, the evaluation line determination unit 2305 calculates parameters by formulae (41) to (43) in such a way as to become parallel to the parallel translation vector “s”. Furthermore, an x-component of the parallel translation vector “s” is assumed to be xₛ, and a y-component thereof is assumed to be yₛ.

$${\text{a}}_{\text{j}} = {\text{-y}}_{\text{s}}$$

$${\text{b}}_{\text{j}} = {\text{x}}_{\text{s}}$$

$${\text{c}}_{\text{j}} = \text{-a} ⋅ {\text{x}}_{\text{j}} \text{- b} ⋅ {\text{y}}_{\text{j}}$$

Moreover, in step S2804, the evaluation line determination unit 2305 sequentially records the parameters calculated in the above-described manner on the evaluation line parameter columns in the list of reference lines.

The evaluation line determination unit 2305 performs the above-described processing in step S2802 to step S2804, thus calculating evaluation lines corresponding to all of the rows for reference lines.

### Color-Difference Map Generation Processing Flow in Step S2406

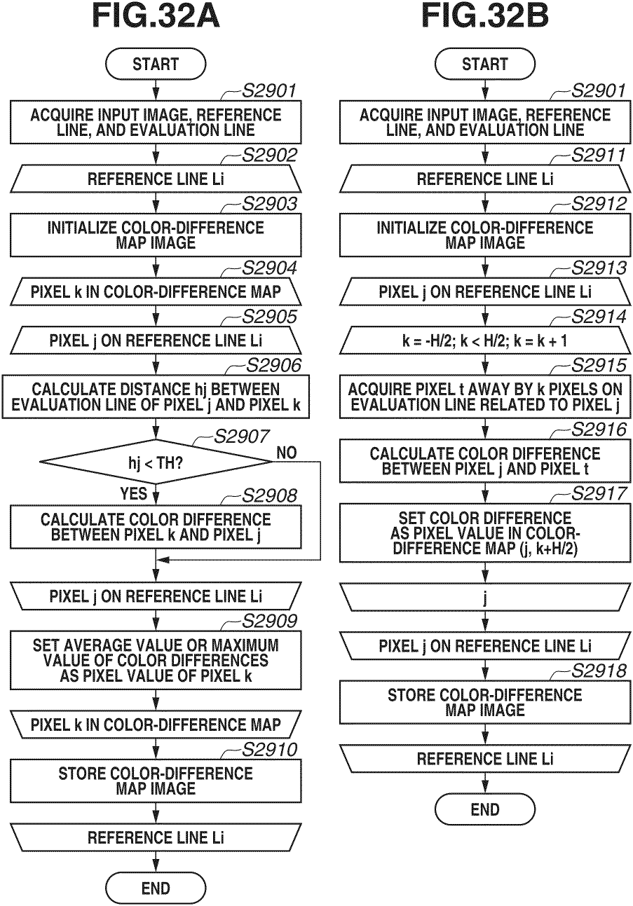

FIGS. 32A and 32B are flowcharts illustrating the detailed flow of color-difference map generation processing which the color-difference map generation unit 2306 performs in step S2406.

In the color-difference map generation processing in step S2406, the color-difference map generation unit 2306 generates a color-difference map which differs between a case where an input image coordinate system option 2511 is selected and a case where an orthogonal coordinate system option 2512 is selected.

In a case where the input image coordinate system option 2511 is selected, the color-difference map generation unit 2306 generates a color-difference map having the same coordinate system as that of an input image. Therefore, the user becomes able to recognize positions of the respective pixels of an input image and color differences thereof while associating them with each other.

On the other hand, in a case where the orthogonal coordinate system option 2512 is selected, the color-difference map generation unit 2306 generates a color-difference map having a coordinate system in which a reference line and an evaluation line are perpendicular to each other. Therefore, the user becomes able to readily recognize how color differences vary according to distances from the reference line.

FIG. 32A is a flowchart of color-difference map generation processing for a case where the input image coordinate system option 2511 is selected.

In step S2901, the color-difference map generation unit 2306 reads an input image and a list of reference lines calculated by processing in up to step S2405.

Next, in loop processing starting with step S2902, the color-difference map generation unit 2306 sets a division number in the list of reference lines as Li, and performs subsequent processing in step S2903 to step S2910 with respect to all of the division numbers while changing Li. Furthermore, in the present processing, a color-difference map which differs for each divisional reference line is generated.

Next, in step S2903, the color-difference map generation unit 2306 allocates a memory region for storing a color-difference map to be generated as two-dimensional image data on the main memory 102, and initializes the memory region with a pixel value “0”. Here, the size of a color-difference map is assumed to be the same size as that of an input image.

Next, in loop processing starting with step S2904, the color-difference map generation unit 2306 performs processing in step S2905 to step S2909 with respect to each pixel of a color-difference map allocated by the above-described processing. The following description is continued with a pixel of interest in this loop set as the k-th pixel.

In loop processing starting with step S2905, the color-difference map generation unit 2306 performs processing in step S2906 to step S2908 with respect to all of the pixels on the divisional reference line, i.e., all of the rows having the same division number Li in the list of reference lines.

In step S2906, the color-difference map generation unit 2306 calculates a distance hⱼ between a straight line determined by evaluation line parameters on the j-th row and the k-th pixel of the color-difference map. This processing is able to be performed by use of formula (44). Here, coordinates of the k-th pixel of the color-difference map are assumed to be (xₖ, yₖ).

$${h}_{j} = \left|{a}_{j} {x}_{k} + {b}_{j} {y}_{k} + {c}_{j}\right| / \sqrt{{a}_{j} {}^{2} + {b}_{j} {}^{2}}$$

Next, in step S2907, the color-difference map generation unit 2306 determines whether the k-th pixel of the color-difference map is present on an evaluation line on the j-th row. Here, if the distance hⱼ is smaller than a threshold value TH, the color-difference map generation unit 2306 determines that the k-th pixel of the color-difference map is present on an evaluation line on the j-th row (YES in step S2907) and then advances the processing to step S2908, and, if not so (NO in step S2907), the color-difference map generation unit 2306 skips processing in step S2908.

In step S2908, the color-difference map generation unit 2306 calculates a color difference between the color of a pixel present at the coordinates (xₖ, yₖ) and the color of a pixel present at the coordinates (xⱼ, yⱼ) on the j-th row of the reference line in the input image. In this processing, the color-difference map generation unit 2306 calculates ΔE according to the above-mentioned formula (10), and then records the calculated ΔE on the main memory 102.

Here, if processing in step S2906 to step S2908 is performed with respect to all of the rows on the reference line Li, since a plurality of evaluation lines intersects with each other on the pixel of interest “k” of the color-difference map, a plurality of color differences may be calculated. Therefore, in step S2909, the color-difference map generation unit 2306 performs processing for calculating a maximum value or average value out of these color differences and setting the maximum value or average value as a pixel value of the pixel of interest “k”. Thus, the color difference of a point at which a plurality of evaluation lines (second line segments) intersects with each other is made to use an average value or maximum value of a plurality of color differences respectively calculated for the plurality of evaluation lines. Furthermore, which of the maximum value and the average value to use can be configured to be selected by the user via, for example, a UI (not illustrated).

Next, in step S2910, the color-difference map generation unit 2306 performs processing for recording a color-difference map generated by processing in step S2904 to step S2909 on the main memory 102 or the HDD 103 while associating the color-difference map with the division number Li of the reference line.

By performing the above-described series of processing operations, the color-difference map generation unit 2306 is able to generate a color-difference map having the same coordinate system as that of an input image for each division number of the reference line.

FIG. 32B is a flowchart of color-difference map generation processing in step-S2406 for a case where the orthogonal coordinate system option 2512 is selected.

In step S2901, the color-difference map generation unit 2306 reads an input image and a list of reference lines calculated by processing in up to step S2405.

Next, in loop processing starting with step S2911, the color-difference map generation unit 2306 sets a division number in the list of reference lines as Li, and performs subsequent processing in step S2912 to step S2918 with respect to all of the division numbers while changing Li. Furthermore, even in the present processing, a color-difference map which differs for each divisional reference line is generated.

In step S2912, the color-difference map generation unit 2306 allocates a memory region for storing a color-difference map to be generated as two-dimensional image data on the main memory 102, and initializes the memory region with a pixel value “0”. Here, the size of a color-difference map is assumed to be W×H pixels with a width W being the number of rows included in the reference line Li and a height H being a previously set number of pixels.

In loop processing starting with step S2913, the color-difference map generation unit 2306 performs processing in step S2914 to step S2917 with respect to all of the pixels on the divisional reference line, i.e., all of the rows having the same division number Li in the list of reference lines.

Moreover, in loop processing starting with step S2914, the color-difference map generation unit 2306 performs processing in step S2915 to step S2917 with respect to the number of pixels H in height of the color-difference map while changing the variable “k” from -H/2 to H/2.

In step S2915, the color-difference map generation unit 2306 calculates coordinates “t” away by k pixels from the coordinate values on the j-th row on a straight line determined by evaluation line parameters on the j-th row of the reference line. Specifically, the color-difference map generation unit 2306 is able to calculate the coordinates “t” by formula (45).

$$\vec{t} = k ⋅ {\left[{b}_{j} , - {a}_{j}\right]}^{t} / \sqrt{{a}_{j} {}^{2} + {b}_{j} {}^{2}} + {\left[{x}_{j} , {y}_{j}\right]}^{t}$$

Next, in step S2916, the color-difference map generation unit 2306 calculates a color difference between the color of a pixel present at the coordinates “t” and the color of a pixel present at the coordinates (xⱼ, yⱼ) on the j-th row of the reference line in the input image. In this processing, the color-difference map generation unit 2306 calculates ΔE according to the above-mentioned formula (10), and then records the calculated ΔE on the main memory 102.

Next, in step S2917, the color-difference map generation unit 2306 performs processing for recording the color difference calculated in step S2916 as a pixel value at the position of the x-coordinate being “j” and the y-coordinate being k+H/2.

After that, in step S2918, the color-difference map generation unit 2306 performs processing for recording a color-difference map generated by processing in step S2913 to step S2917 on the main memory 102 or the HDD 103 while associating the color-difference map with the division number Li of the reference line.

By performing the above-described series of processing operations, the color-difference map generation unit 2306 is able to generate a color-difference map having a coordinate system in which a reference line and an evaluation line are perpendicular to each other for each division number of the reference line.

In the fifth exemplary embodiment, an example of extracting a boundary line from captured image data and calculating a reference line and an evaluation line based on the boundary line has been described. Thus, according to the information processing apparatus in the fifth exemplary embodiment, it becomes possible to perform evaluation of color differences corresponding to distances from a boundary between different components. Moreover, manually setting a reference line or an evaluation line for every evaluation has a disadvantage that the direction of an evaluation line may vary each time, thus making it impossible to perform stable evaluation. On the other hand, in the case of the present exemplary embodiment, since a reference line and an evaluation line are determined based on a boundary line, the direction of an evaluation line does not vary each time, thus making it possible to perform stable evaluation.

While, in the fifth exemplary embodiment, an example of extracting a boundary line from captured image data and setting the extracted boundary line has been described, the present exemplary embodiment is not limited to this, and, for example, a configuration in which the user manually draws a boundary line or the user selects a boundary line from among a plurality of boundary line candidates displayed as options can be employed.

Moreover, while, in the present exemplary embodiment, a configuration in which a reference line is determined based on a boundary line and a reference point has been described, the reference point does not necessarily need to be designated. Information other than the reference point can be used as long as it is information for enabling discriminating a distance between the reference line and the boundary line and on which of the right and left sides of the boundary line to set the reference line. For example, a configuration in which a plurality of candidates for the reference line is presented and the user selects a reference line from among the presented plurality of candidates can be employed. In this case, in the flowchart of FIG. 27A, a plurality of values of the distance D between the boundary line and the reference point can be previously set and reference lines calculated for the respective values can be used as the candidates. Moreover, if, with regard to the respective values of the distance D, reference lines are calculated for two cases where the cross product vector gⱼ is [0, 0, 1] and [0, 0, -1], reference lines present on both sides of the boundary line can be set as the candidates.

While, in the above-described exemplary embodiments, ΔE, ΔL, Δa and Δb are used as the types of difference information about colors, for example, ΔC or Δh can be used.

Moreover, while, with regard to the types of difference information about colors, ΔE1976 is used as ΔE, an evaluation value representing a difference between colors, such as ΔE1994 or ΔE2000, can be used.

Moreover, while Lab is used as color information, a psychophysical value such as JCH can be used.

While, in the above-described second exemplary embodiment, an example of performing designation of a starting point and an ending point to set an evaluation line has been described, the starting point of a reference line can be set as the starting point of an evaluation line and the evaluation line can be set based on such a starting point and a point different from any point on the reference line. The point different from any point on the reference line is assumed to be, for example, the ending point of the evaluation line. Thus, the evaluation line can be set by setting the starting point of the reference line as the starting point of the evaluation line and designating only the ending point of the evaluation line.

According to aspects of the present disclosure, it becomes possible to generate a color-difference map applicable to various uses and needs.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors, circuitry, or combinations thereof (e.g., central processing unit (CPU), micro processing unit (MPU, or the like)), and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2022-000995 filed Jan. 6, 2022, which is hereby incorporated by reference herein in its entirety.

What is claimed is:

1. An information processing apparatus comprising:
a first setting unit configured to set a first line segment in an image obtained by image capturing;
a second setting unit configured to set a second line segment in the image;
a color difference acquisition unit configured to acquire color differences between points on the first line segment and points on the second line segments; and
a generation unit configured to generate a color-difference map based on the acquired color differences.

2. The information processing apparatus according to claim 1, wherein the second line segment is a line segment perpendicular to the first line segment.

3. The information processing apparatus according to claim 1, wherein the second line segment is a line segment corresponding to a vertical direction or a horizontal direction of the image.

4. The information processing apparatus according to claim 1, wherein the second setting unit sets the second line segment in such a manner that the second line segment intersects with the first line segment.

5. The information processing apparatus according to claim 1, wherein the second setting unit sets the second line segment based on a starting point and an ending point which have been set.

6. The information processing apparatus according to claim 1, wherein the second setting unit sets the second line segment based on a starting point of the first line segment and a point different from any point on the first line segment.

7. The information processing apparatus according to claim 1, further comprising a rectangle setting unit configured to set a rectangle with respect to the image,
wherein the second setting unit sets the second line segment based on the rectangle.

8. The information processing apparatus according to claim 7, wherein the second setting unit sets the second line segment corresponding to a vertical direction or a horizontal direction of the rectangle.

9. The information processing apparatus according to claim 1, wherein the first line segment is a line segment configured with a starting point, an ending point, and one or more nodes present between the starting point and the ending point.

10. The information processing apparatus according to claim 9, wherein the second setting unit performs setting in such a manner that a second line segment in a section connecting between adjacent ones of the nodes does not intersect with a second line segment in a section connecting between other ones of the nodes within a predetermined region.

11. An information processing apparatus comprising:
a boundary setting unit configured to set a boundary line for performing region segmentation of an image obtained by image capturing;
a first setting unit configured to set a first line segment away by a predetermined distance from the boundary line; and
a second setting unit configured to set a second line segment for determining a direction to extract, from the image, a color to be compared with a color of each point on the first line segment.

12. The information processing apparatus according to claim 11, further comprising:
a color difference acquisition unit configured to acquire color differences between points on the first line segment and points on the second line segments; and
a generation unit configured to generate a color-difference map based on the acquired color differences.

13. The information processing apparatus according to claim 12, wherein the second setting unit sets a direction of the second line segment based on the first line segment.

14. The information processing apparatus according to claim 13,
wherein the first setting unit sets the first line segment away by the predetermined distance from the boundary line in a direction perpendicular to the boundary line, and
wherein the second setting unit sets a direction perpendicular to the first line segment as the direction of the second line segment.

15. The information processing apparatus according to claim 13,
wherein the first setting unit sets the first line segment away by the predetermined distance from the boundary line in a direction to perform parallel translation of the boundary line, and
wherein the second setting unit sets the direction of parallel translation as the direction of the second line segment.

16. The information processing apparatus according to claim 12,
wherein the first setting unit divides the boundary line at a changing point of the boundary line and sets a plurality of first line segments each corresponding to the first line segment for respective boundary lines obtained by dividing the boundary line, and
wherein the second setting unit sets the second line segment for each of the plurality of first line segments.

17. The information processing apparatus according to claim 16, wherein the generation unit generates the color-difference map corresponding to each of the boundary lines obtained by dividing the boundary line.

18. The information processing apparatus according to claim 17, wherein, in the color-difference map, a color difference of a point at which a plurality of second line segments each corresponding to the second line segment set for the respective plurality of first line segments is an average value or a maximum value of a plurality of color differences calculated for the respective plurality of second line segments.

19. The information processing apparatus according to claim 17, wherein the generation unit generates the color-difference map in a coordinate system in which the first line segment and the second line segment intersect with each other.

20. An information processing method comprising:
setting a first line segment in an image obtained by image capturing;
setting a second line segment in the image;
acquiring color differences between points on the first line segment and points on the second line segments; and
generating a color-difference map based on the acquired color differences.

21. An information processing method comprising:
setting a boundary line for performing region segmentation of an image obtained by image capturing;
setting a first line segment away by a predetermined distance from the boundary line; and
setting a second line segment for determining a direction to extract, from the image, a color to be compared with a color of each point on the first line segment.

22. A non-transitory computer-readable storage medium storing instructions that, when executed by a computer, cause the computer to perform an information processing method comprising:
setting a first line segment in an image obtained by image capturing;
setting a second line segment in the image;
acquiring color differences between points on the first line segment and points on the second line segments; and
generating a color-difference map based on the acquired color differences.

23. A non-transitory computer-readable storage medium storing instructions that, when executed by a computer, cause the computer to perform an information processing method comprising:
setting a boundary line for performing region segmentation of an image obtained by image capturing;
setting a first line segment away by a predetermined distance from the boundary line; and
setting a second line segment for determining a direction to extract, from the image, a color to be compared with a color of each point on the first line segment.
